(19) United States
(12) Patent Application Publication
(10) Pub. No.: US 2009/0290649 A1
(43) Pub. Date: Nov. 26, 2009

(54) SIGNAL PROPAGATION CIRCUIT AND SIGNAL PROCESSING APPARATUS

(75) Inventor: Tsz shing CHEUNG, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/358,364

(22) Filed: Jan. 23, 2009

(30) Foreign Application Priority Data
May 26, 2008 (JP) 2008-136254

(51) Int. Cl. H04B 3/00

(52) U.S. Cl. 375/257

(57) ABSTRACT

There provided are a substrate, on which are formed a signal propagation path to propagate a signal from an input end, in which signal propagation path a terminating resistance coupled to an output end substantially matches impedance; and a transmission line formed in anon-contact manner with the signal propagation path at a position halfway trough the signal propagation path. This arrangement realizes high-sensitivity detection of electric signals.

### CROSS-REFERENCE TO RELATED APPLICATION(S)

This application is based upon and claims the benefit of priority of the prior Japanese Patent Application No. 2008-136254, filed on May 26, 2008 in Japan, the entire contents of which are incorporated herein by reference.

### FIELD

The present case relates to a signal propagation circuit and the signal processing apparatus.

### BACKGROUND

Recently, devices for performing signal detection with high sensitivity are demanded as electric circuits which are widely applied to electronic equipment. In such devices, it is required that attenuation of output signals and deterioration of a Signal to Noise Ratio (SNR), obtained as a detection result, are avoided as much as possible. On the other hand, high-functionality electric circuit devices such as those which perform over-sampling of high-frequency signals are also demanded.

Devices for detecting signals having high-frequencies with high sensitivity (high speed) as described above are demanded in various types of electronic equipment or the like which digitalize input analogue electric signals.

As an example, at the reception end in a high-speed data communications system using light signals, the signal amplitude is digitalized for demodulating data from input electric signals having been subjected to optic to electric conversion. At that time, to demodulate data at fine signal quality while supporting speed-enhancement in data rate, a signal detection function which is capable of performing over-sampling of high-frequency signals with a low-load circuit construction is required.

### SUMMARY

Therefore, one of the objects of the present proposition is to make it possible to detect electric signals with higher sensitivity than that in the previous art.

The following means, for example, are used.

(1) As a generic feature, there provided is a signal propagation circuit, comprising: a substrate, which comprises: a signal propagation path to propagate a signal from an input end, in which signal propagation path a terminating resistor coupled to an output end substantially matches impedance; and a transmission line formed in a non-contact manner with the signal propagation path halfway trough the signal propagation path.

(2) As another generic feature, there provided is a signal processing apparatus, comprising: a substrate, which comprises: a signal propagation path circuit comprising: a signal propagation path to propagate a signal from an input end, in which signal propagation path a terminating resistor coupled to an output end substantially matches impedance; and a transmission line formed in a non-contact manner with the signal propagation path halfway trough the signal propagation path; and a signal processing unit to perform signal processing by use of a second signal output from the transmission line together with a first signal output from the output end of the signal propagation path.

(3) As yet another generic feature, there provided is a signal processing apparatus, comprising: a clock signal outputting unit to generate a first and second clock signal from a common clock; the first and the second transmission line each to transmit therethrough a first and a second clock signal output from the clock signal output unit; a first and a second phase detecting unit each to detect a phase of each of the first and the second clock signal; and a clock controlling unit to control the clock signal outputting unit, the first and the second phase detecting unit each comprising: a substrate, which comprises: a signal propagation path to propagate a clock signal from the first and the second input end, in which signal propagation path a terminating resistor coupled to an output end substantially matches impedance; a signal propagation circuit including a transmission line formed in a non-contact manner with the signal propagation path halfway through the signal propagation path; and a signal processing unit to induce a phase of the clock signal due to signal processing by use of a first signal output from the output end of the signal propagation path together with a second signal output from the transmission path, and the clock controlling unit controlling the clock signal outputting unit in such a manner that the first and the second clock signal generated by the clock signal outputting unit are substantially in synchronization therewith in accordance with the phases of the first and the second clock signal induced by the signal processing units in the first and the second phase detecting unit.

Additional objects and advantages of the invention (embodiment) will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is a diagram illustrating an example of an ADC system as a composition construction example of a signal processing apparatus according to a first embodiment;

FIG. 2(A) is a diagram illustrating a signal processing apparatus according to the first embodiment;

FIG. 2(B) is a diagram for describing processing performed on the signal processing apparatus;

FIG. 3(A) through FIG. 3(C) are diagrams illustrating an example of a concrete construction of a signal propagation circuit in a case of transmission line arrangement pattern #2; FIG. 3(D) is a graph indicating frequency response characteristics of the signal propagation circuit;

FIG. 4 is a table exemplifying materials which are used to form a dielectric substrate;

FIG. 5(A) through FIG. 5(C) are diagrams for describing inducement of a coefficient K due to DSP together with multiplication performed by a multiplier;

FIG. 6(A) and FIG. 6(B) are diagrams for describing an example of inducement of SNR on an ADC in the signal processing apparatus according to the first embodiment;

FIG. 7 is a graph indicating an simulation example of a signal waveform output from the output end of the signal propagation path, a signal waveform propagating through the transmission path, and an output signal from DSP;

FIG. 8 is a graph for describing effects and benefits obtained in the first embodiment;

FIG. 9(A) through FIG. 9(C) are graphs for describing effects of improvement in a capacity load in is a signal processing apparatus depicted in FIG. 2 which is given in comparison with the ADC system in FIG. 1;

FIG. 10 and FIG. 11 each are diagrams for describing effects and benefits obtained in the first embodiment;

FIG. 12 is a diagram illustrating a signal processing apparatus according to a second embodiment;

FIG. 13(A) and FIG. 13(B) are diagrams for describing a processing operation in the signal processing apparatus according to the second embodiment;

FIG. 14 is a diagram illustrating a signal processing apparatus according to a third embodiment;

FIG. 15 is a diagram illustrating a signal processing apparatus according to a fourth embodiment;

FIG. 16 is a diagram for describing an operation mode of a signal processing apparatus according to a fourth embodiment;

FIG. 17 is a diagram illustrating a signal processing apparatus according to a fifth embodiment;

FIG. 18(A) through FIG. 18(C) and FIG. 19 are diagrams illustrating a signal processing apparatus according to a sixth embodiment;

FIG. 20(A) and FIG. 20(B) are diagrams illustrating a signal processing apparatus according to a modified example of the sixth embodiment;

FIG. 21(A) through FIG. 21(D) and FIG. 22(A) through FIG. 22(C) are diagrams illustrating the signal processing apparatus according to a modified example of the sixth embodiment;

FIG. 23(A) is a diagram illustrating a signal propagation circuit according to a seventh embodiment;

FIG. 23(B) is a graph indicating frequency response characteristics of a signal in the signal propagation circuit according to the seventh embodiment;

FIG. 24(A) is a diagram illustrating a signal propagation circuit according to an eighth embodiment;

FIG. 24(B) is a diagram illustrating a signal propagation circuit according to a modified example of the eighth embodiment;

FIG. 25(A) is a diagram illustrating a signal propagation circuit according to a ninth embodiment; FIG. 25(B) is a table indicating an example of a set of design parameters;

FIG. 26(A) is a diagram illustrating an equivalent circuit of a signal propagation circuit according to the ninth embodiment; FIG. 26(B) is a graph indicating frequency response characteristics of signals in the signal propagation path according to the ninth embodiment;

FIG. 27(A) and FIG. 27(B) are graphs indicating frequency response characteristics of the signal propagation circuit according to the ninth embodiment;

FIG. 28(A) is a diagram illustrating an equivalent circuit with an attention paid to a case where the signal propagation circuit depicted in FIG. 28(B) is applied as a signal propagation circuit of the signal processing apparatus according to the first embodiment; FIG. 28(B) is a diagram illustrating a signal propagation circuit according to a 10th embodiment; FIG. 28(C) is a graph indicating frequency response characteristics of a signal propagation circuit according to the first embodiment;

FIG. 29(A) is a diagram illustrating an equivalent circuit with an attention paid to a case where the signal propagation circuit depicted in FIG. 29(B) is applied as a signal propagation circuit of the signal processing apparatus according to the first embodiment; FIG. 29(B) is a diagram illustrating a signal propagation circuit according to a modified example of a 10th embodiment; FIG. 29(C) is a graph indicating frequency response characteristics of the signal propagation circuit according to the 10th embodiment;

FIG. 30(A) and FIG. 30(B) are diagrams illustrating a signal propagation circuit according to a 11th embodiment; FIG. 30(C) is a table indicating an example of a set of design parameters;

FIG. 31 is a graph indicating frequency response characteristics of the signal propagation circuit according to the 11th embodiment;

FIG. 32 is a diagram illustrating a modified example of the 11th embodiment;

FIG. 33 is a graph indicating frequency characteristics of the modified example depicted in FIG. 32;

FIG. 34 is a diagram illustrating a modified example of the 11th embodiment;

FIG. 35 is a graph indicating frequency response characteristics of the modified example depicted in FIG. 34;

FIG. 36(A) through FIG. 36(C), FIG. 37(A), and FIG. 37(B) are diagrams illustrating modified examples of the 11th embodiment;

FIG. 38 is a graph indicating frequency response characteristics of a modified example depicted in FIG. 37; and

FIG. 39 is a graph indicating frequency response characteristics of a modified example depicted in FIG. 37.

### DESCRIPTION OF EMBODIMENTS

Referring to the relevant drawings, a description will be made hereinafter of preferred embodiments. Here, the embodiments described below are merely examples, and there is no intention to exclude application of various types of modifications or techniques not explicitly described in the following descriptions. That is, the present embodiment should by no means be limited to the illustrated embodiment below, and various changes or modifications (combination of practical examples, or the like) may be suggested without departing from the gist of the invention.

### [A] First Embodiment

Analogue to digital converters (hereinafter, will be also called “ADCs”) are important components in signal interfaces of communications and electronic equipment. In many electronic equipment, the ADCs provide vital transformation of analogue signals into digital codes. More precisely, the ADCs perform amplitude equalization of an analogue input signal into binary output words usually in a range of a natural number of bits.

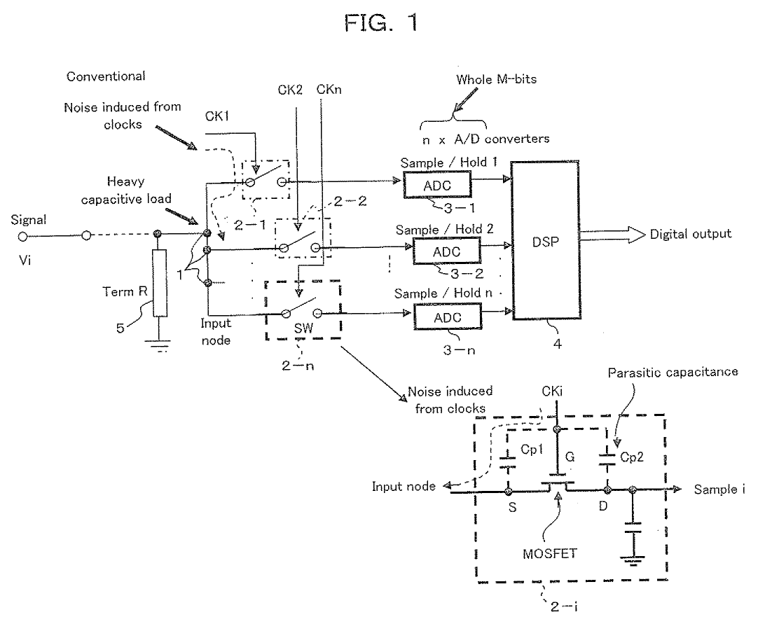

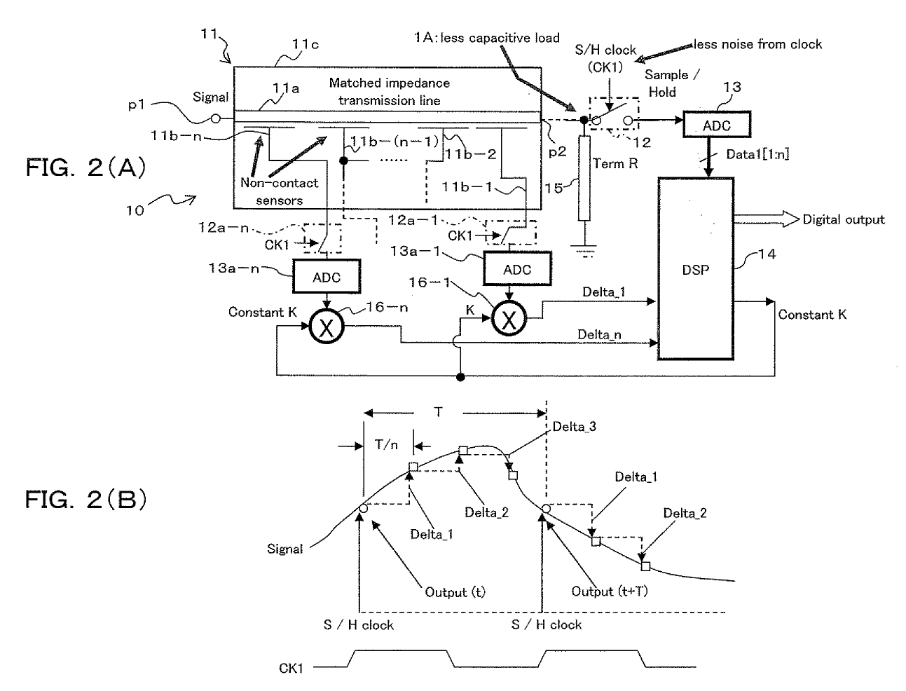

FIG. 1 illustrates an example of an ADC system as an example of a contrast construction of a signal processing apparatus 10 [see FIG. 2(A)] according to a first embodiment. The ADC system exemplified in FIG. 1 has an input contact (input node) 1 for branching an input signal input from the input end PI into more than one (n in FIG. 1) signal. Here, each of the sample holding circuits 2-i (i: 1 through n) performs sample holding of the signal from the input node 1 with clocks CKi.

Further, the ADCs 3-1 through 3-n digitalize the signals from the sample holding circuits 2-1 through 2-n, respectively. Still further, a Digital Signal Processor (DSP) 4, which is a digital signal processing unit, outputs an digital signal, which is a result of AD conversion of the input signal, from the outputs from the ADCs 3-1 through 3-n with digital signal processing. In this instance, the reference character 5 indicates a terminating resistor which performs impedance matching to a transmission path that is coupled to the input contact 1 and extends from the input end PT to the input contact 1.

In the ADC system illustrated in FIG. 1, the sample holding circuit 2-i is formed by, for example, a Metal-oxide-Semiconductor Field-Effect Transistor (MOSFET), and samples the input signal by use of interleave clocks CKi with different phases thereof, and output the sampling result to the corresponding ADC 3-i (±1 through n). Then, the DSP 4 receives the digital signals, which are sampling results from the ADCs 3-1 through 3-n as a total of M bits, and outputs an analogue to digital converted signal obtained by, for example, over-sampling as a result of digital signal processing.

In the ADC system exemplified in FIG. 1, comparatively in any circuit load is caused at the input nodes 1 having many branches. Further, the sample holding circuit 2-i forms the capacity load due to practical capacities Cp1 and Cp2 to the transmission line side of the input node 1 and the transmission line side of the corresponding ADC 3-i. That is, the clock signal from each of the sample holding circuits 2-1 through 2-n is lead to the input node 1 and causes interference. This interference causes distortion of the waveforms of the signals input to the ADCs 3-1 through 3-n each of which performs sampling because of noises added thereto.

Such circuit load and capacity load at the input node 1 makes it difficult to satisfy the requirements for achieving a transmission speed not lower than, for example, 20 Gbps. That is, it is not easy for the circuit depicted in FIG. 1 to be applied to a communications circuit that accomplishes a transmission speed not lower than 20 Gbps.

Therefore, the first embodiment proposes such a signal processing apparatus as is illustrated in FIG. 2(A). The signal processing apparatus 10 depicted in FIG. 2 includes: a signal propagation circuit 11; sample holding circuits 12 and 12a-1 through 12a-n; ADCs 13, 13a-1 through 13a-n; a DSP 14; a terminating resistor 15; and multipliers 16-1 through 16-n.

That is, in the signal processing apparatus illustrated in FIG. 2(A), at the positions (input contact 1A) to which the terminating resistor 15 is coupled, a single sample holding circuit 12 is serially coupled in spite of multiple of those arranged in parallel.

The signal propagation circuit 11 is formed by a terminating resistor 15 coupled to the output end p2, a signal propagation path 11a in which impedance substantially matches the terminating resistor 15 coupled to the output end p2 and which propagates therethourgh a signal from the input end p1, and multiple (here, n-number of) transmission lines 11b-i (i: 1 through n) one of whose ends is formed in a non-contact manner with the signal propagation path 11a halfway through the signal propagation path 11a. The above elements are provided on the dielectric substrate 11c.

That is, the signal processing apparatus 10 according to the first embodiment has only one signal propagation path 11a which matches the terminating resistor 15 (5), differing from the above case described with reference to FIG. 1. This arrangement reduces circuit load at an input contact 1. Further, the sample holding circuits 12a-i which are coupled to the transmission lines 11b-i, respectively, are non-contacted with the input node 1A, so that it is possible to reduce the capacity load to the input node 1A and to reduce the noise being generated.

In this instance, the term, “substantially”, means that deviation of values in the range in which systems are operable in view of the technological level at the time of filing of the present application is included in consideration of manufacture errors or design errors.

The signal propagation path 11a has a length equivalent to propagation of a length not shorter than a half cycle length of propagation of a signal that is a subject of the detection (here, for example, a length of unit cycle), and leads the signal from the input end p1 to the output end p2. Further, the transmission paths 11b-1 through 11b-n propagate therethrough a signal in accordance with the signal variation amount at phase timing in accordance with a distance difference in the signal propagation path from a position at which the terminating resistor 15 is connected to the corresponding positions at which the transmission lines are formed. Accordingly, the signal propagation circuit 11 functions as a front-end sensor which outputs the signal that is a subject of detection from the output end p2 of the signal propagation path 11a and also outputs a signal in accordance with the signal variation amount through transmission lines 11b-i.

Multiple transmission lines 11b-i can be arranged at substantially equal distances across a length of the signal propagation path 11a from an input end p1 to the output end p2. For example, as an example where three transmission lines 11b-1 through 11b-3 are formed, the transmission lines 11b-1 and 11b-2 are arranged at the two positions at equal distances, which two positions divide the signal propagation path 11a equally among three, and the transmission line 11b-3 can be arranged at the position corresponding to the input end.

In other words, as to the n-number of transmission lines 11b-1 through 11b-n, the transmission lines 11b-1 through 11b-(n−1) are arranged at the positions which divide the signal propagation path 11a equally among n; the signal transmission path 11b-n is arranged at the position corresponding to the input end of the signal propagation path 11a (transmission line arrangement pattern #1).

As another example, the transmission paths 11b-1 through 11b-3 are arranged in a non-contact manner with the signal propagation path 11a at the three positions at equal distances, which three positions divide the signal propagation path 11a equally among four. In other words, the n-number of transmission lines 11b-i (i: 1 through n) in this case can be arranged at the positions at equal distances, which positions divide the signal propagation path 11a equally among (n+1) (transmission line arrangement pattern #2).

In this instance, as will be described later, an output of the signal propagation path 11a and an output of the transmission lines 11b-i are subjected to sample holding substantially in synchronism by use of a common clock CK1. At that time, the signal component subjected to the sample holding at the transmission lines 11b-i can be used for sampling performed between the output of the signal propagation path 11a at the subject timing and the subsequent timing.

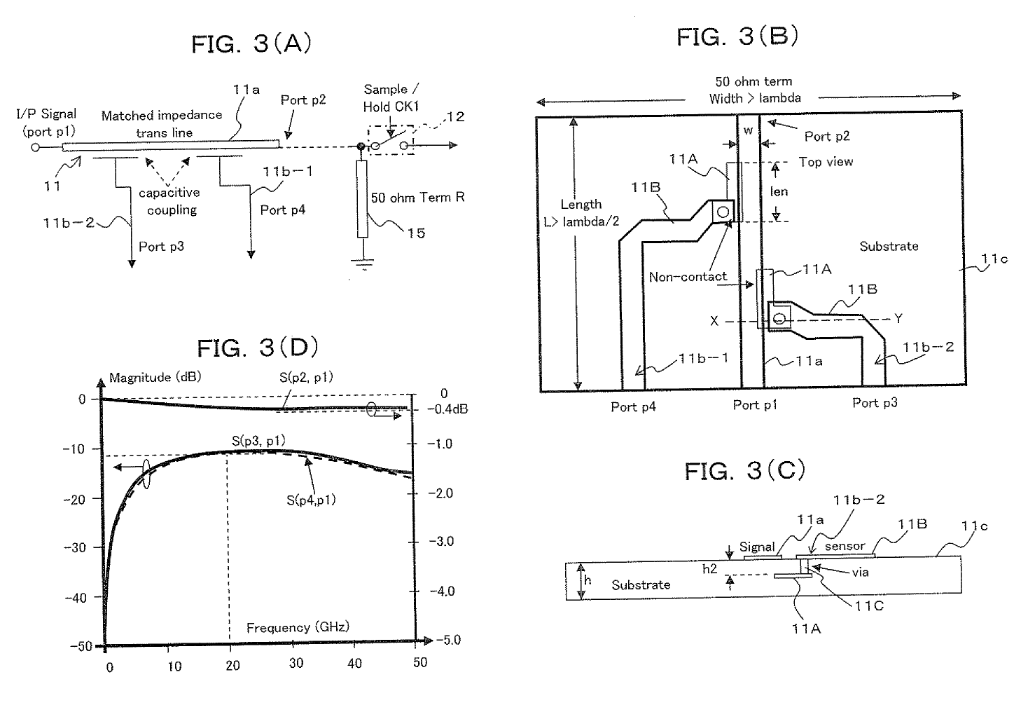

FIG. 3(A) through FIG. 3(C) are diagrams illustrating an example of a concrete construction of a signal propagation circuit 11 in a case of transmission line arrangement pattern #2. FIG. 3(A) illustrates the terminating resistor 15 and a sample holding circuit 12 together with the equivalent circuit of the signal propagation circuit 11; FIG. 3(B) is a top view of the signal propagation circuit 11; and FIG. 3(C) is a X-Y sectional view of FIG. 3(B).

The dielectric substrate 11c can be a substrate having a length of L (>λ/2; λ is a signal wavelength propagating through the signal propagation path 11a) and a width of W (>λ), and has a signal propagation path 11a formed thereon. Further, two transmission lines 11b-1 and 11b-2 are formed on the dielectric substrate 11c.

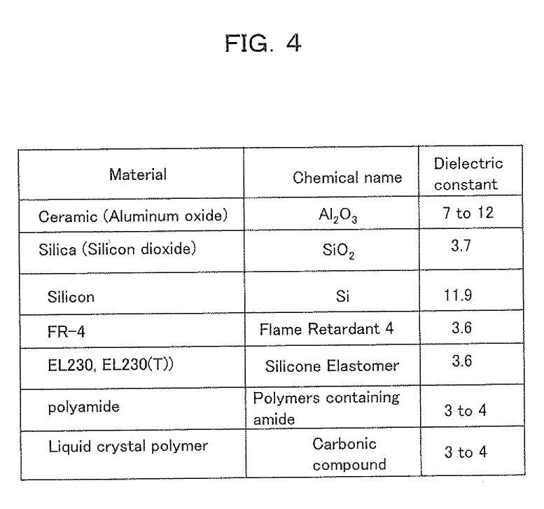

In FIG. 3(B), the transmission paths 11b-1 and 11b-2 are formed in a non-contact manner with the signal propagation path 11a at the two positions at equal distances, which two positions divide the signal propagation path 11a equally among three. In this instance, the dielectric substrate 11c can be realized by, for example, dielectric material as illustrated in FIG. 4.

As illustrated in FIG. 3(C), the signal propagation path 11a is formed on the dielectric substrate 11c. In contrast to this, the transmission path 11b-2 is capable of including: a first transmission line portion 11A, provided inside the dielectric substrate 11c, for regulating a distance h2 from the signal propagation path 11a; a second transmission line portion 11B, provided on the dielectric substrate 11c, for realizing conduction with the first transmission line portion 11A; and a lead-through conductor 11C for passing therethrough the first transmission line portion 11A and the second transmission line portion 11. The same goes for the transmission line 11b-1.

In this instance, in FIG. 3(A) and FIG. 3(B), the port p1 indicates the input end of the signal propagation path 11a; the port p2 indicates the output end of the signal propagation path 11a. Further, the port p3 indicates the other end of the transmission line 11b-2 coupled to the sample holding circuit 12a-2; the port p4 indicates the other end of the transmission line 11b-1 coupled to the sample holding circuit 12a-1.

The first transmission line portion 11A is formed in a non-contact manner with the signal propagation path 11a halfway through the signal propagation path 11a substantially with a predetermined interval therefrom. Further, the second transmission line portion 11B forms a transmission line pattern on the dielectric substrate 11c conductively connected to the first transmission line portion 11A. With this arrangement, although both of the transmission paths 11b-1 and 11b-2 are in a non-contact condition with the signal propagation path 11a at the first transmission line portion 11A, they are electrically coupled thereto, and it is thus possible to propagate a detection signal with respect to a signal propagating through the signal propagation path 11a.

In the example depicted in FIG. 3(B), the transmission paths 11b-1 and 11b-2 are formed in a non-contact manner with the signal propagation path 11a substantially with a predetermined interval h2 in the depth direction of the dielectric substrate 11c.

Further, the length (the coupling length of the transmission line 11b-i with the signal propagation path 11a), len, of the signal propagation path 11a extending in the direction of the signal propagation path 11a having a predetermined interval with the first line portion 11A can be about 0.5 mm, as an example. The setting of such a physical length makes it possible to apply the Printed Circuit Board (PCB) technology and the Large Scale Integration (LSI) technology to the signal propagation circuit 11.

Still further, in FIG. 2(B), the sample holding circuit 12 is coupled to the output end p2 of the signal propagation path 11a to perform sampling of the signal from the output end p2 in synchronization with a clock (CK1). The ADC 13 converts the signal sampled by the sample holding circuit 12 into a digital signal (bit signal) and then outputs the obtained digital signal to the DSP 14.

In contrast to this, the sample holding circuit 12a-i (i; 1 through n) performs sample holding of each of the signals propagating through the transmission path 11b-11n synchronization with the clock (CK1) applied at the sample holding circuit 12. Then, the signal subjected to the sample holding by the sample holding circuit 12a-i can be regarded as a signal component delayed on the time axis with respect to the signal output form the output end p2 of the signal propagation path 11a in accordance with the positions at which the corresponding transmission paths 11b-1 through 11b-n are formed.

That is, the sample hold signal in the sample holding circuit 12a-i corresponds to a signal on the time axis which delays for the propagation delay distance, from the output end p2 to the position at which the transmission line 11b-i is formed, with respect to the sample hold signal at the sample holding circuit 12.

At that time, the transmission line 11b-i input to the sample holding circuit 12-i is formed in anon-contact manner with the signal propagation path 11a. Therefore, the transmission line 11b-i propagates therethrough an alternating current component from which a direct current component is substantially removed, out of the signal propagating through signal propagation path 11a, as a detection signal, at a position at which the corresponding first transmission line portion 11A is formed. The sample holding circuit 12-i is made to perform sample holding of an alternation current component forming the above described detection signal.

Then, the ADC 13a-i (i; 1 through n) converts the signal sampled by the corresponding sample holding circuit 12a-i into a digital signal (bit signal).

FIG. 2(B) is a diagram for describing a signal subjected to sample holding performed by the sample holding circuits 12a-1 through 12a-3 in the signal processing apparatus depicted in FIG. 2(A) in a case where n=3 in the transmission line arrangement pattern #2.

The sample holding circuit 12 performs sample holding of the signal level of the signal input from the output end p2 (input contact 5A) of the signal propagation path 11a at time point t where the clock CK1 comes up. Each of the sample holding circuits 12a-1 through 12a-3 performs sample holding of the signal level at the same time position t1, which signal propagates at the position upstream from the input contact 1A by the position of the signal propagation path 11a where the corresponding transmission paths 11b-1 through 11b-3 are formed in a non-contact manner.

On the assumption that the length of the signal propagation path 11a is the propagation distance corresponding to the cycle T of the clock CK1, the sample holding circuit 12 performs sample holding of the signal level [Output (t)] at the time point t. The sample holding circuit 12a-i performs the sample holding of the signal level that reaches the input contact 1A at the time point t+T·(i/n+1)[t+T·(i/T) in the case of the transmission line arrangement pattern #1].

Then, the sample holding circuit 12a-i performs sample holding of a difference signal (or a differentiation signal) of the delay signal delayed in accordance with the propagation delay time of the signal propagation path 11a with respect to the signal at the time of the precedent sample holding circuit 12a-(i−1) before one stage. This difference signal being subjected to the sample holding is a variation amount signal Delta_i. The sample holding circuit 12a-1 performs sample holding of the variation signal Delta_1 with respect to the signal level which is subjected to the sample holding performed by the sample holding circuits 12.

In the cases of FIG. 3(A) through FIG. 3(C), n takes 2 in the transmission line arrangement pattern #2. Thus, the sample holding circuit 12a-1 performs sample holding of the variation amount signal (Delta_1) with respect to the signal level whose sample holding is performed by the sample holding circuit 12, as the signal propagating through the transmission path 11b-1.

Likewise, the sample holding circuit 12a-2 performs sample holding of the variation amount signal (Delta_2) of the signal that reaches the input contact 1A at the time point t+2T/3. Here, the variation amount signal Delta_2 is a difference signal with respect to the signal level at the time point at which the sample holding circuit 12a-1 performs sample holding performed by the precedent sample holding circuit 12a-1 before one stage.

In this manner, to substantially obtain further opportunities of two times of sampling in the unit cycle of CK1, the signal transmission paths 11b-1 and 11b-2 are formed that are capable of propagating the signal level between the sampling clocks CK1 as a difference signal.

Further, use of a common clock CK1 in the sample holding circuits 12 and 12a-1 through 12a-n makes it possible to simplify the circuit construction for generating a clock, in comparison of that which is illustrated in FIG. 1. It is further possible to reduce interference noise between clock signals.

Hence, the above described sample holding circuits 12 and the ADC 13 have a function as the first digitalizing unit that performs sampling of the signal (first signal) output from the output end p2 of the signal propagation path 11a in synchronization with the first clock that outputs the sampling result as a digital signal.

Further, the above described sample holding circuits 12a-i and the ADC 13a-i (i=1 through n) have a function of the second digitalizing unit that performs sampling of the variation amount signal Delta_i according to the variation amount of the signal propagating through the signal propagation path 11a, which variation signal propagates through the corresponding transmission line 11b-i, as a second signal, in synchronization with the first clock, and that outputs the sampling result as a digital signal.

The multipliers 16-1 through 16-n depicted in FIG. 2(A) execute arithmetic operations for level correction or resolution correction of the digital signals from the ADCs 13a-1 through 13a-n to equalize the number of digits of the bits of the digital signal from the ADC 13 under control from the DSP 14.

Further, the DSP 14 is input thereto with the sampled signal values (digital signals) from the above described ADC 13 and 13a-1 through 13a-n, and then performs processing or operations of the signal input through the input end p1. According to the first embodiment, as an example, the DSP 14 outputs a signal obtained by digitalizing the analogue electric signal input from the input end p1, which signal is a digital signal decreased in error in comparison with that in the above described FIG. 1.

More concretely, the DSP 14 outputs a signal input as an analogue signal through the input end p1 as a digital signal as a result of digital conversion thereof. On the other hand, the DSP 14 controls the coefficient K for resolution correction performed by the multipliers 16-1 through 16-n in accordance with the variation amount signal values from the ADC 13 and 13a-1 through 13a-n.

Hence, at least, the above described sample holding circuit 12a-i and the ADC 13a-i function as a signal processing unit for performing signal processing by use of the second signal output from the transmission line 11b-i together with the first signal output from the output end p2 of the signal propagation path 11a. Further, together with the above described sample holding circuits 12a-i and the ADC 13a-i, it can be taken as a function as a signal processing unit including the DSP 14.

FIG. 3(D) is a graph indicating input and output characteristics in accordance with the frequency of the signal propagating through the signal propagation circuit 11. In this FIG. 3(D), S(p2, p1) indicates output signal level characteristics with respect to the input of the signal lead from the input end p1 of the signal propagation path 11a to the output end p2 of the signal propagation path 11a that is an output port p2.

In contrast to this, S(p4, p1) and S(p3, p1) each are output signal level characteristics with respect to the input signal of the variation amount signal lead from the input end p1 of the signal propagation path 11a to the other ends p4 and p3 of the transmission paths 11b-2 and 11b-1, respectively.

As indicated by S(p2, p1) of this FIG. 3(D), the signal output from the output end p2 hardly attenuates in a range of 0 GHz through 50 GHz, and its level is kept not lower than about −0.4 dB. In contrast to this, as indicated by S(p4, p1) and S(p3, p1), the variation amount signals output from the other ends p4 and p3 of the transmission line 11b-2 and 11b-1, respectively, do not propagate a low-frequency component around 0 Hz. However, as to the high-frequency domain (for example, not lower than 20 GHz), which mainly corresponds to the bit rate of a communications signal, the attenuation is restrained at about −12 dB, and becomes about ⅕ of the input signal level.

In the DSP 14, the levels of the signals output from the other ends p4 and p3 of the transmission lines 11b-2 and 11b-1, respectively, are made to be even with the level of the signal output from the output end p2 as a result of the arithmetic operation of increasing the level of the signals output from the other ends p4 and p3 of the transmission lines 11b-2 and 11b-1 by K, which operation is performed by the multipliers 16-1 and 16-2, by means of giving the coefficient K for use in multiplication performed by the multipliers 16-1 and 16-2.

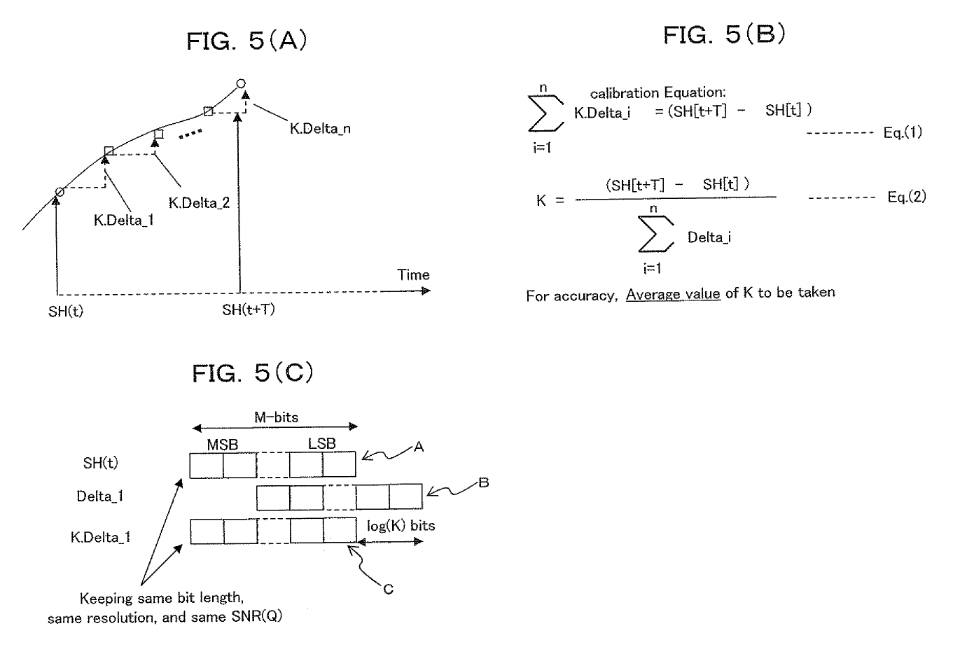

FIG. 5(A) through FIG. 5(C) are diagrams for describing the multiplications performed by the multipliers 16-1 and 16-2 together with the induction of the coefficient K performed by the above described DSP 14. It is given that the signal level sampled by the sample holding circuit 12 in synchronization with clock CK1 at a cycle of T is SH. At that time, the level difference SH(t+T)−SH(t) between the signal levels sequentially sampled is expressed by the following formula (1) by use of the variation signal amount Delta_i sampled by the sample holding circuit 12-i [see FIG. 5(B)].

$${\sum }_{i = n}^{n} K \cdot Delta\_i = ( SH ( t + T ) - SH ( t ) ) \qquad ( 1 )$$

In this instance, here, the transmission line arrangement pattern #1 is in consideration. That is, the transmission lines 11b-1 through 11b-(n−1) propagating therethrough the variation amount signal have the (n−1)-number of positions which divide the signal propagation path 11a equally among n; the signal transmission path 11b-n is arranged at the point corresponding to the input end of the signal propagation path 11a.

Here, it is assumed that the average level of the variation signal from the transmission lines 11b-i is 1/K of the signal level propagating through the signal propagation path 1a. At that time, as indicated in FIG. 5(A), it can be said that Sh(t+T)−SH(t) is equal to the sum of the values obtained by multiplying the signal Delta_i obtained by sample holding performed by the sample holding circuit 12a-i by each level adjustment value K.

As a result, the value of K is capable of being is obtained by the following formula (2):

$$K = \frac{( SH ( t + T ) - SH ( t ) )}{{\sum }_{i - 1}^{n} Delta\_i} \qquad ( 2 )$$

The multiplier 16-i is input thereto with the variation signal Delta_i, obtained by sample holding performed by the sample holding circuit 12a-i, from the ADC 13-i as a digital signal, and also with the level correction coefficient K from the DSP 14. The multiplier 16-i then multiplies the Delta_i by K. FIG. 5(C) is a diagram for describing the multiplication performed by the multiplier 16-i.

Since each ADC 13a-i performs digital conversion of the sample value of the variation signal propagating through the transmission line 11b-i, any of them has the similar resolution (the absolute uppermost bit level [MS B] is equal to the absolute lowermost bit level [LSB]) [see reference character B of FIG. 5(C)]. In contrast to this, since the ADC 13 performs digital conversion of the sample value of the signal propagating through the signal propagation path 11a, it has a resolution different from that of the ADC 13a-i, but the number of bits itself is an M-bit word equivalent therewith [see reference character A of FIG. 5(C)].

The multiplier 16-i increases the digital signal from the ADC 13a-i by K. The thus obtained digital signal becomes the value of an M-bit word which is made to be even with the digital signal from the ADC 13 in absolute uppermost bit level and absolute lowermost bit level [see reference character C of FIG. 5(C)]. Substantially, multiplication performed in the multiplier 16-i provides a value equivalent to the value that is obtained by bit-shifting of the digital signal from the ADC 13a-i by log(K) bits. With this arrangement, the DSP 14 is induced thereto with a value that makes the arithmetic operation processing easy.

Accordingly, the above described multiplier 16-i performs a correction operation of the resolution of the digital signal from the ADC 13a-i, and functions as a resolution correcting unit that outputs the digital signal, having been subjected to the correction operation to the DSP 14. The DSP 14 functions as a resolution correction controlling unit for controlling the correction operation, performed by the multiplier 16-i based on the digital signal from the ADC 13.

In this instance, in a case where the transmission lines 11b-1 through 11b-n are arranged at the n-number of positions which divide the signal propagation path 11a equally among n+1 (transmission line arrangement pattern #2), the DSP 14 is capable of calculating the value of K from the variation signal level Delta_i propagating through the transmission lines 11b-1 through 11b-n.

For example, in a ramp signal or a triangular waveform signal whose signal voltage level inclination is fixed, if any of the values of Delta_i is found, it is possible to calculate the sum of Delta_i from the value, so that it is possible for the DSP 14 to induce the optimal K value. Alternatively, the optimal K value for the input signal can be calculated beforehand.

In the signal processing apparatus 10 with the above described construction, the signal input from the input end propagates through the signal propagation path 11a and is output from the output end p2. The signal output from the output end p2 is terminated by the terminating resistor 15, and its sample value is held by the sample holding circuit 12 in synchronization with the clock CK1. The ADC 13 converts the sample value held in the sample holding circuit 12 into a digital signal and is then output to the DSP 14.

On the other hand, the sample holding circuit 12a-i extracts the variation amount signal halfway through the propagation in the signal propagation path 11a by way of the transmission line 11b-i formed in a non-contact manner halfway through the propagation in the signal propagation path 11a. That is, the sample holding circuit 12a-i performs sample holding of the variation amount signal Delta_i at the timing that forms the gap of the timing at which the sample holding circuit 12 performs sample holding while still using the same sampling clock as that of the sample holding circuit 12.

Then, the ADC 13a-i converts the variation amount signal having been subjected to the sample holding by the sample holding circuit 12a-i into a digital signal. After performing a resolution correction operation for the digital signal from the ADC 13a-i, the multiplier 16-i outputs the operation result to the DSP 14.

In this manner, the DSP 14 captures the signal sample value at intervals shorter than the sampling intervals in the ADC 13 while yet using the sampling clock CK1. This makes it possible to output a digital signal as an AD conversion result having a fine SNR with respect to the input signal by an interpolation operation by use of the sample value between the clock signals.

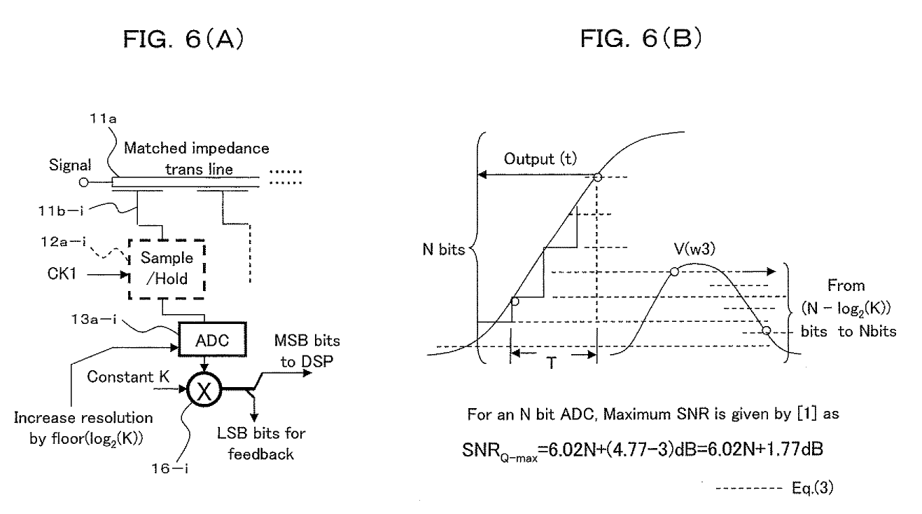

FIG. 6(B) is a diagram for describing an example of inducement of an SNR by the ADC 13a-11n the signal processing apparatus 10 according to the first embodiment. Assuming that N is the number of output bits of the ADC 13 based on the following formula (3) and the document (VLSI: Design of Analog and Digital Circuits, R. L. Reiger), the maximum SNR (Q value) due to digitization errors is equal to 6.02N+177 dB.

SNRQ−MAX=6.02N+(4.77−3)dB=6.02N+1.77dB (3)

That is, as to the signal (V (w3)) subjected to digital conversion performed by the ADC 13a-i, the SNR is in proportion to the number of digitization levels while it is in inverse proportion to the resolution value. In a case where the SNR is sufficiently high, the resolution of the signal subjected to digital conversion by the ADC 13a-i is remained to be a value substantially equivalent to the resolution of the signal (Output (t)) from the output end. The digitalization level lowers down to N-log₂ (K). When the ADC 13a-i requires an SNR (Q value) equivalent to that of the ADC 13, it is possible to set the digitization level to N, so that the SNR and the quality of the AD conversion do not deteriorated.

In this instance, as illustrated in FIG. 6(A), out of the digital signals output from the multiplier 16-i, the MSB bit is output to the DSP 14 while the LSB bit can be used as another feedback element.

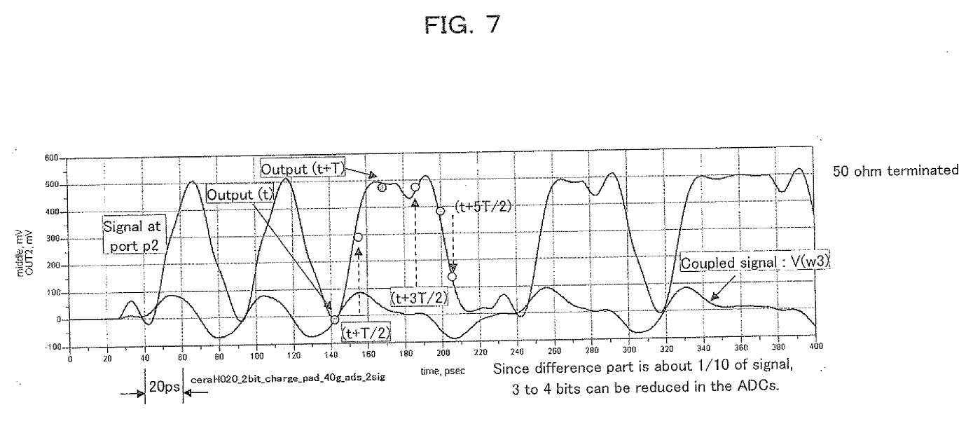

FIG. 7 is a graph indicating simulation examples of a signal waveform (signal at port p2) output from the output end of the signal propagation path 11a, a signal waveform [Coupled signal V(w3)] propagating through the transmission line 11b-i, and an output signal [Output (t+kT/2); k is a natural number] from the DSP 14.

As indicated in this FIG. 7, the output signal output from the DSP 14 accurately interpolates the value forming the gap of the sampling clock CK1 in the ADC 13.

That is, accurate sampling of the value of Output (t+mT/2) (m is an even number) in accordance with the sampling data obtained by the ADC 13 with the sampling clock CK1 is executed. In addition, as to the value of Output (t+pT/2) (p is an uneven number) forming the interpolation value by use of the value from the ADC 13a-i, also, accurate sampling of the level of the signal waveform output from the output end of the signal propagation path 11a is executed.

In this instance, the level of the difference signal sampled by the ADC 13a-i, forming a difference part, is capable of being reduced by about 3 through 4 bits in comparison with the ADC 13, as the quantization level in the ADC 13a-i in a case where the above difference signal level becomes about 1/10 of the signal level sampled by the ADC 13.

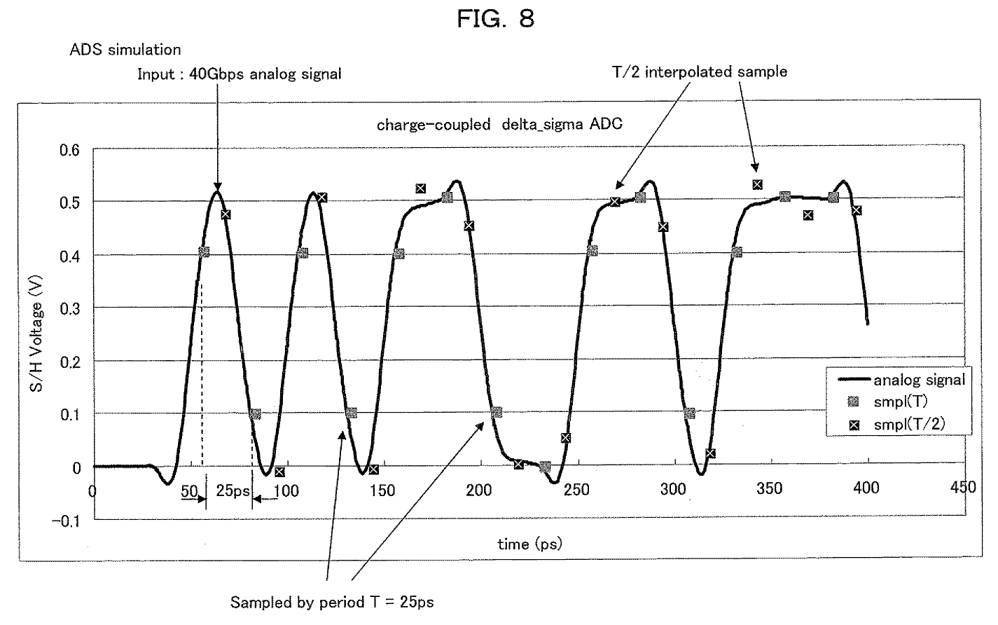

FIG. 8 is a graph indicating a case (a+b) where the sample value from the ADC 13a-i is used together with the sample value from the ADC 13 as a digital conversion result and a case (a) where the variation signal from the ADC 13a-i is not used as a signal of the digital conversion result, in comparison with an original analogue signal waveform. Here, as an example, an analogue signal of 40 Gbps is used for an original analogue signal. As indicated in FIG. 8, the case (b) is capable of restoring the original signal waveform accurately in comparison with the case (a).

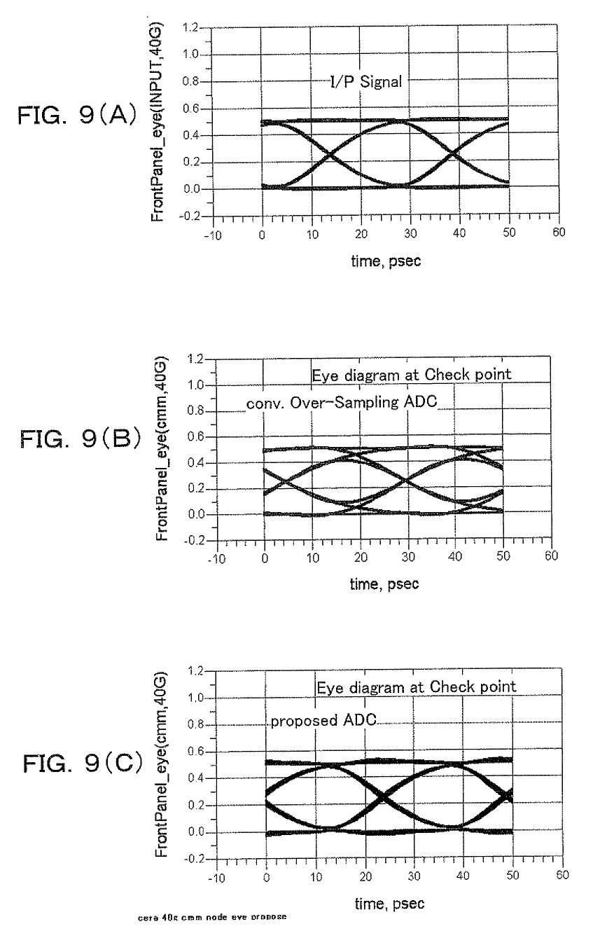

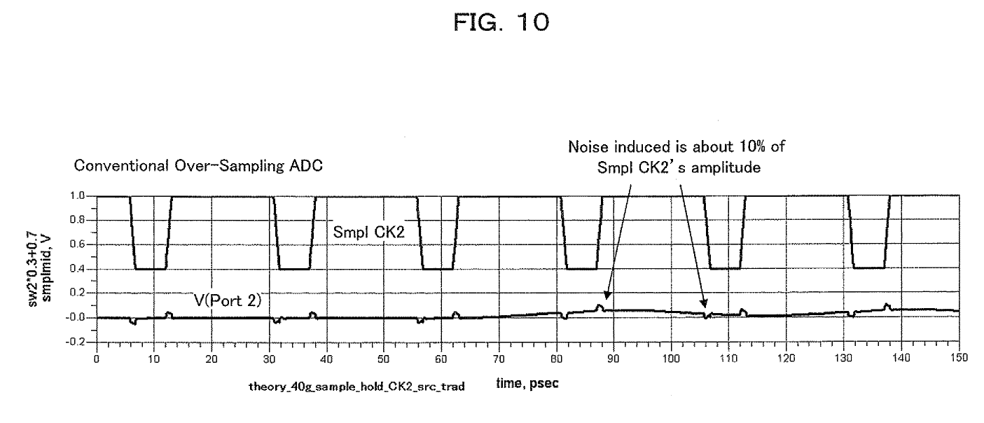

FIG. 9(A) through FIG. 9(C) are diagrams for describing improvement effects in capacity load of the signal processing apparatus 10 illustrated in FIG. 2 in comparison with the ADC system of FIG. 1. In a case where the input signal having an eye pattern indicated in FIG. 9(A), the eye pattern at a specific check point (Eye-diagram at Check point) of the digital signal output as an AD conversion result in the ADC system in FIG. 1 becomes that which is indicated in FIG. 9(B). On the other hand, the AD conversion result in the signal processing apparatus 10 of FIG. 2 becomes that which is indicated in FIG. 9(C).

Since the capacity load at the contact 1A to which the terminating resistor 15 is coupled is reduced in comparison with the contact 1 in FIG. 1, it is possible to suppress the attenuation of the signal. With the suppressing effects of the attenuation of this signal, the deterioration of the eye diagram is also improved [FIG. 9(C)] in comparison with the case of the ADC system of FIG. 1 [FIG. 9(B)].

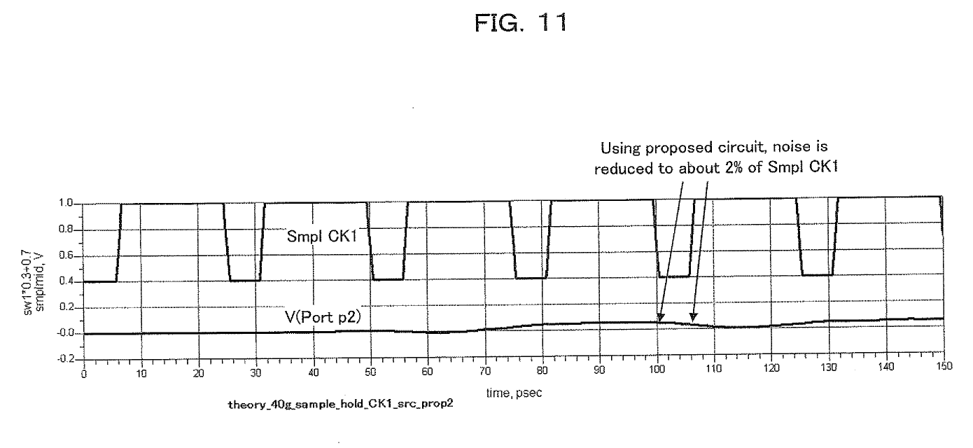

FIG. 10 is a graph indicating noise (V) due to a component of the clock CKi mixed to the input contact 1, together with one clock pulse (Smpl CK2) in the ADC system in FIG. 1. Further, FIG. 11 is a graph indicating noise (V) due to a component of the clock CKi mixed to the input contact 1A, together with a clock (Smpl CK1) together with a clock commonly used in the signal processing apparatus 10 illustrated in FIG. 2(A).

Here, in the ADC system illustrated in FIG. 1, the clock CKi is mixed to the input contact 1 by way of multiple sample holding circuit 2-i. Thus, as indicated in FIG. 10, the amplitude level of the clock noise at the input contact 1 can turn to be about 10% of the amplitude of the original clock signal CKi. Such clock noise can cause data error in the ADC 3-i of the later stage.

In contrast to this, in the signal processing apparatus 10 illustrated in FIG. 2(A), as to the origin of the clock CK1 mixed to the input contact 1A, it is only necessary to assume a single sample holding circuit 12 coupled to the input contact 1A. Therefore, the amplitude of the clock noise at the input contact 1A indicated in FIG. 11 is capable of being decreased down to about 2% of the amplitude of the original clock signal CK1. This makes it possible to significantly suppress data error in comparison with the ADC system depicted in FIG. 1 in the signal processing apparatus 10 illustrated in FIG. 2(A).

In this manner, in the signal processing apparatus 10 according to the first embodiment, it is possible to detect an electric signal in a hypersensitive manner to the previous technology. In addition, since it is possible to capture the sample hold value and the variation amount signal with a finer SNR from the ADC 13 and the ADC 13a-i (multiplier 16-i), AD conversion with high accuracy can be realized.

### [b] Second Embodiment

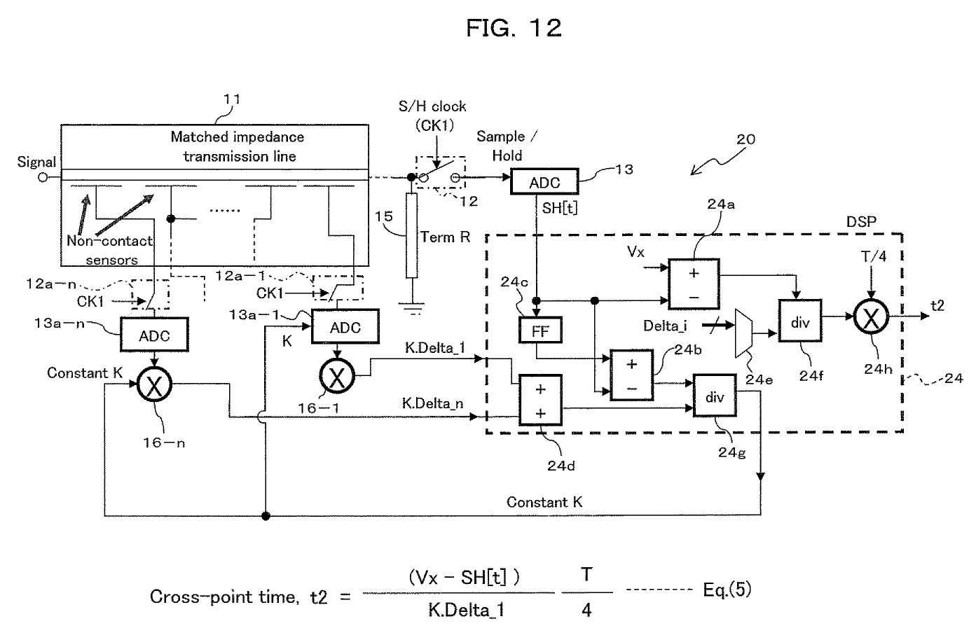

FIG. 12 is a diagram illustrating a signal processing apparatus 20 according to the second embodiment. The signal processing apparatus 20 depicted in FIG. 12 has a DSP 24 that is equivalent to the DSP 14 of the signal processing apparatus 10 according to the above described first embodiment with additional functions added thereto. That is, with an arithmetic operation performed by the DSP 24, demodulation of the optical phase modulated signal is performed by use of the sample data input from the ADC 13 and 13-i with an arithmetic operation performed by the DSP 24.

As an example, the DQPSK (Differential Quadrature Phase Shift Keying) light signal input through the propagation path is received by a light receiving element, which is not illustrated, and an electric signal obtained as a result of the light reception is input to the input end p1 of the signal propagation path 11a forming the signal processing apparatus 20.

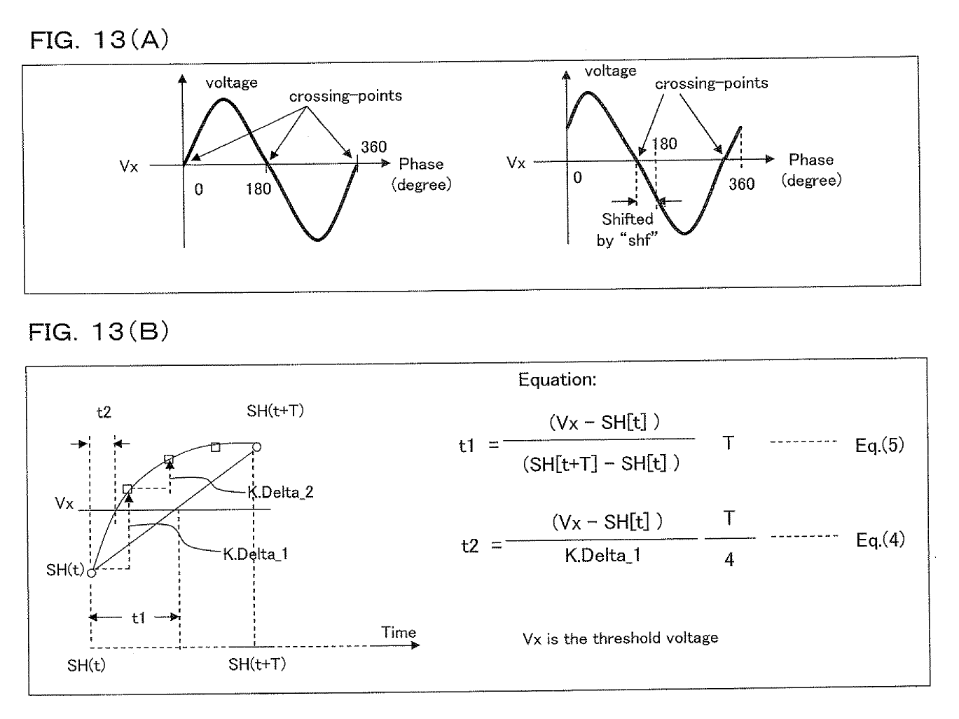

FIG. 13(A) is a diagram for describing the signal waveform in the above mentioned DQPSK system or CDR (Clock Data Recovery). In these systems, calculation of cross point time is required for performing demodulation of the DQPSK signal and clock extraction.

In the DSP 24 forming the signal processing apparatus 20 according to the second embodiment, the sample value of the electric signal that is input to this input end p1 and propagates through the signal propagation path 11a is captured from the ADCs 13 and 13a-i. With this arrangement, the cross point time, from sampling timing to timing with a reorganization point level, is obtained.

Here, as a function for obtaining the cross point, the DSP 24 equivalently includes: difference operators 24a and 24b; a flip-flop (FF) 24c; an adder 24d; a serial/parallel converter 24e; dividers 24f and 24g, and a multiplier 24h.

That is, the difference operator 24a, the serial/parallel 24e, the divider 24f, and the multiplier 24h obtain the cross point time t2 substantially in accordance with the following formula (4) Further, the FF 24c, the difference operator 24b, the adder 24d, and the divider 24g make it possible to obtain the resolution K, supplied to the multiplier 16-i, substantially in accordance with the above formula (2).

$$t 2 = \frac{( Vx - SH ( t ) )}{K . Delta\_i} \cdot \frac{T}{n} \qquad ( 4 )$$

Here, Vx corresponds to the recognition level. As described above, the cross point time is given by a time difference from the timing of the clock CK1 subjected to the sample holding to the timing at which the signal propagating through the signal propagation path 11a and the recognition level cross each other.

In FIG. 12, given that n=4, four transmission lines 12i-1 through 12i-4 can be formed as the transmission line arrangement pattern #1. In this case, as exemplified in FIG. 13(B), the value obtained in a division i in which the across point exists, by dividing the detection value K.Delta_i [K.Delta_1 in FIG. 13(B)] from the multiplier 16-i by T/4 indicates the amount of change of the detection value (here, a voltage value) in a division containing the cross point. Therefore, the cross point time t2 is capable of being obtained by dividing the above mentioned Vx−SH(t) by the above mentioned change amount.

In this instance, which one of the divisions K.Delta_1 through K.Delta_n the division that forms the recognition point level Vx forming the cross point corresponds to, can be specified by use of each of the change amount signals K.Delta_1 through K.Delta_n captured by the multiplier 16-i in the DSP 24.

The cross point time in a case where the ADC system depicted in FIG. 1 is applied, is given by t1 indicated in the following formula (5). Hence, for calculating the cross point time by the DSP 4, it is necessary to calculate a difference SH(t+T)−SH(t) between sequential sampling data items from the ADC 13. Thus, operation load in the DSP 4 becomes relatively large.

$$t 1 = \frac{( Vx - SH ( t ) )}{( SH ( t + T ) - SH ( t ) )} \cdot T \qquad ( 5 )$$

In contrast to this, in the signal processing apparatus 20 depicted in FIG. 12, it is unnecessary to calculate a difference SH(t+T)−SH(t) between the sequential sampling data items. Instead, as indicated in the above formula (4), the signal processing apparatus 20 of FIG. 12 directly uses the output of the multiplier 16-i that outputs the signal corresponding to the change amount signal in the division in which the cross point is present, as the detection value. As a result, the operation load on the DSP 24 is significantly reduced in comparison with that in the DSP 4 of the ADC system depicted in FIG. 1.

In this instance, as indicated in FIG. 13(A), the DSP 24 demodulates the DQPSK-modulated signal by means of calculating the phase shift amount shf using the obtained cross point time. The phase shift amount shf is capable of being induced substantially in accordance with the following formula (6) by use of the cross point time t2 obtained as described above.

shf=360(t2/T)[degree] (6)

The signal processing apparatus 20 with the above described construction input thereto with the phase-modulated signal through the input end p1, and the DSP 24 calculates a phase deviation amount with respect to the inter-symbol timing relating to the phase modulation as cross point time t2 based on the digital signal from the ADC 13 and the ADC 13a-i. The DSP 24 is capable of demodulating the phase-modulated signal by use of the thus calculated cross point time t2.

In this manner, according to the second embodiment, also, it is possible to detect an electric signal in a hypersensitive manner to the previous technology. In addition, it is possible to capture the sample hold value and the variation signal with a finer SNR from the ADCs 13-i and 13a-i (multiplier 16-i). It is also possible to simplify the load necessary for demodulation processing.

### [c] Third Embodiment

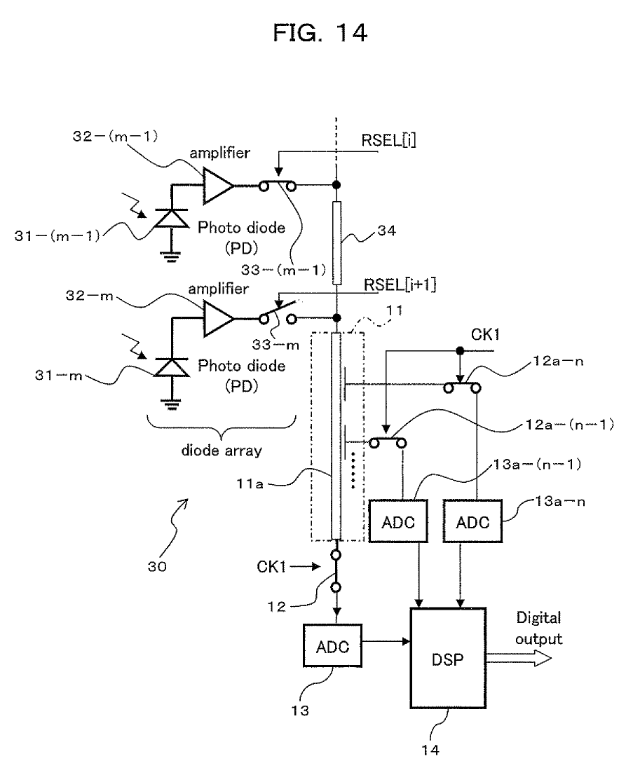

FIG. 14 is a diagram illustrating a signal processing apparatus 30 according to the third embodiment. The signal processing apparatus 30 depicted in FIG. 14 is equivalent to the above described signal processing apparatus 10 according to the first embodiment further including a light receiving element (photodiodes in FIG. 14) 31 that receives light and leads the signal in accordance with the light reception result to the input end p1 of the signal propagation circuit 11.

More specifically, in FIG. 14, multiple (here, the m-number of) light receiving elements 31-j (j; 1 through is m; m is a number larger than one) are arranged in an array form, and amplifiers 32-j for amplifying the output from each of the light receiving elements 31-j.

Then, the output from the amplifier 32-j is directly or indirectly coupled to the input end p1 of the signal propagation circuit 11 by way of the selector 33-j. More specifically, the output from the amplifier 32-m is directly coupled to the signal propagation circuit 11 by way of the selector 33-m. However, the output from the amplifier 32-(m−1) is coupled to the input end p1 by way of the selector 33-(m−1) and the resistor 34.

In this instance, the selector 33-(m−1) is coupled to the upstream side of the selector 33-m, viewed from the input end p1, by way of the resistor 34. Likewise, given that k=2 through m, the selector 33-k is coupled to the selector 33-p when given that p=1 through (m−1) by way of the resistor 34.

With this arrangement, the selector 33-j receives a select signal RSEL(j) which turns one ON and the other is OFF. This makes it possible for the selector 33-j to output the signal from the light receiving elements 31-j with selective switching therebetween. This select signal RSEL(j) sent to the selector 33-j can be given from the DSP 14, or can be given from other control functions such as a function of setting performed by an operator.

In the signal processing apparatus 30 with the above described construction, the received light signal from a single light receiving element 31-j, which is selected by the selector 33-i, is input to the input end p1 of the signal propagation circuit 11 by way of the amplifier 32-j, the selector 33-j, and the resistor 34. Then, as to the signal propagating through the signal propagation path 11a, the DSP 14 takes in the digital signal from the ADC 13 together with the digital signal (change amount signal) from the ADC 13a-i.

This arrangement makes it possible for the DSP 14 to convert the received signal from the light receiving element 31-j selected by the selector 33-j into a digital signal with a high SNR.

In this manner, according to the third embodiment, also, similar to the first embodiment, it is possible to detect an electric signal in a hypersensitive manner to the previous technology. In addition, it is also possible to realize AD conversion with higher accuracy than that of the previous technology while sharing a function as the signal processing apparatus 10 for performing AD conversion of the reception signal from multiple light receiving elements 31-j.

### [d] Fourth Embodiment

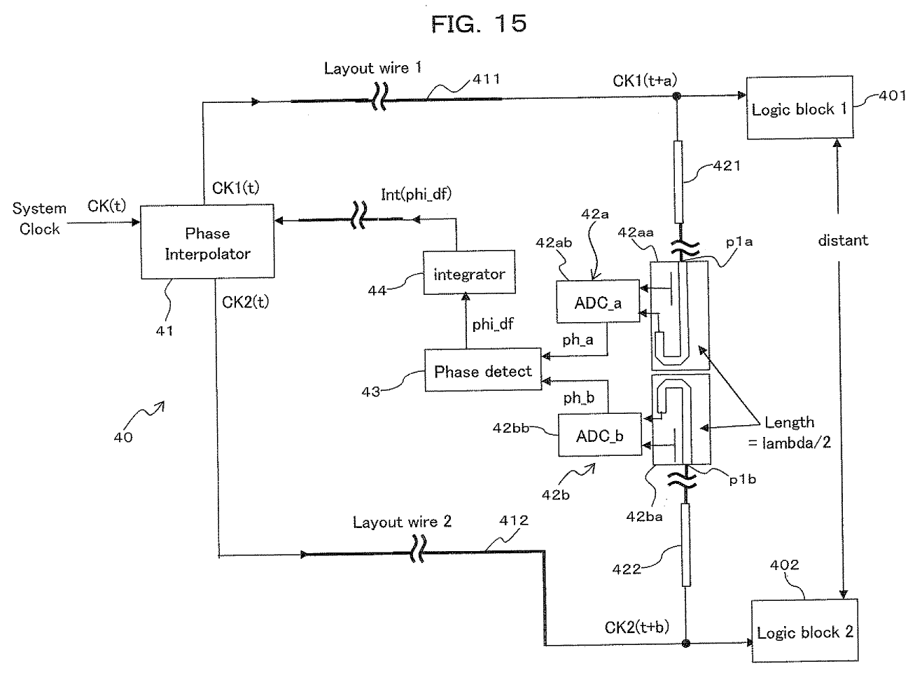

FIG. 15 is a diagram illustrating a signal processing apparatus according to the fourth embodiment. In the signal processing apparatus 40 depicted in FIG. 15, a common clock signal source is applied to multiple (two, in the forth embodiment) logic blocks 401 and 402 which are isolated from each other. In this case, since the clock signal source supplies a clock signal to each of the logic blocks 401 and 402, clock supply transmission lines (layout wires) 411 and 412 are separately arranged.

However, there is a case in which it is difficult to make the lengths of the clock supply transmission lines 411 and 412 the same due to the requirement of positions at which the logic blocks 401 and 402 are arranged. Thus, in a case where an operation in which the logic blocks 401 and 402 are in synchronization with each other is necessary, it is demanded that the input clock signals be in synchronization with each other regardless of the lengths of the transmission lines.

The signal processing apparatus 40 in the fourth embodiment includes: a phase interpolator 41; a first ADC system 42a; a second ADC system (ADC_b) 42b; a phase detector 43; and an integrator 44. This arrangement makes it possible to make the clock signals sent to the logic blocks 401 and 402 in synchronization with each other regardless of the lengths of the clock supply transmission lines 411 and 412.

The phase interpolator 41 is a clock signal outputting unit for generating a first and a second clock signal CKa and CKb. More specifically, a system clock, which is a clock signal from one clock signal source, is introduced to output the clock signals CKa and CKb to the logic blocks 401 and 402, respectively. The clock signals CKa and CKb output from the phase interpolator 41 are supplied to the logic blocks 401 and 402 through the clock supply transmission lines 411 and 412, respectively.

Here, in a case where the phase interpolation to the clock signals CKa and CKb is not yet performed, the clocks are output in the same phase [CKa (t) and CKb (t)]. Assuming that the phase shift of the clock signal due to the propagation in the clock supply transmission line 411 is “a” and that the phase shift of the clock signal due to the propagation in the clock supply transmission line 412 is “b”, the phase of the clock signal to the logic block 401 derives from the phase of the clock signal to the logic block 402 by a phase difference of “b-a”.

As described later, the phase interpolator 41 performs phase interpolation of the clock signals at the time of their outputting to the clock supply transmission lines 411 and 412 under control from the integrator 44. This substantially makes the clock signals CKa and CKb at the time they are input to the logic blocks 401 and 402 in synchronization with each other.

The ADC systems 42a and 42b are phase detecting units each of which detects the phase of the clock signals from the clock supply transmission lines 411 and 412, respectively. The number of ADC systems are in accordance with the number of clock supply transmission lines that are subjects of phase detection. In the present embodiment, two ADC systems, the first and the second ADC systems 42a and 42b, are provided.

Here, in the first ADC system 42a, the clock signal CKa (t+a) supplied to the logic block 401 is captured in from the feedback wire 421 branched from the clock input end to the logic block 401, and the clock signal is then converted into a digital signal. Likewise, in the second ADC system 42b, the clock signal CKb (t+b) supplied to the logic block 402 is captured from the feedback wire 422 branched from the clock input end to the logic block 402, and the clock signal CKb (t+b) is then converted into a digital signal.

Here, each of the first ADC system 42a and the second ADC system 42b has the elements (see reference characters 11 through 15, 12a-1, 13a-i, and 16-i) forming the above described signal processing apparatus 10. In this instance, in FIG. 15, the elements of the first ADC system 42a are indicated as signal propagation circuits 42aa and an ADC unit 42ab. Likewise, the elements of the second ADC system 42b are indicated as a signal propagation circuit 42ba and an ADC unit 42bb.

Here, the signal propagation circuits 42aa and 42ba correspond to the signal propagation circuit 11 of FIG. 2(A). The input ends p1a and p1b of the signal propagation circuits 42aa and 42ba, respectively, are input thereto with signals CKa (t+a) and CKb (t+b) from the clock supply transmission lines 411 and 412, respectively, by way of the feedback wires 421 and 422 having substantially the same length and the same delay time. In this instance, the signal propagation path [see reference character 11a of FIG. 2(A)] forming both of the signal propagation circuits 42aa and 42ba has a length equivalent to ½ of the wavelength of the clock signal propagating through the signal propagation circuits 42aa and 42ba.

Further, the ADC units 42ab and 42bb include function elements indicated by the reference characters 12 through 15, 12a-1, 13a-i, and 16-i. That is, the ADC units 42ba and 42bb output the signals CKa (t+a) and CKb (t+b), which are to be subjected to AD conversion, as digital signals. The ADC units 24ab and 42bb can output phase detection information ph_a and ph_b (at substantially the same timing).

The phase detector 43 is input thereto with the signals CKa (t+a) and CKb (t+b), having been subjected to AD conversion, from the ADC units 42ab and 42bb, and then detects a difference phi_df of the phases ph_a and ph_b (at substantially the same timing) of the signals CKa (t+a) and CKb (t+b), respectively.

The integrator 44 performs a cumulative operation (integration operation) during a predetermined time duration to the phase difference information phi_df detected by the phase detector 43, and then outputs the operation result int (phi_df) to the phase interpolator 41.

With this arrangement, the phase interpolator 41 uses the operation result Int(phi-df) from the above mentioned integrator 44 as control information, to make it possible to perform phase interpolation of the clock signals CKa (t+a) and CKb (t+b) having phase shifts a and b at the time at which those signals are input to the logic blocks 401 and 402.

Hence, the above described phase detector 43 and the integrator 44 construct a clock controlling unit. That is, the phase detector 43 and the integrator 44 control the phase interpolator 41 in such a manner that the clock signals CKa and CKb generated by the phase interpolator 41 are substantially in synchronization with each other in accordance with the phases of the clock signals CKa and CKb induced by the ADC systems 42a and 42b, respectively.

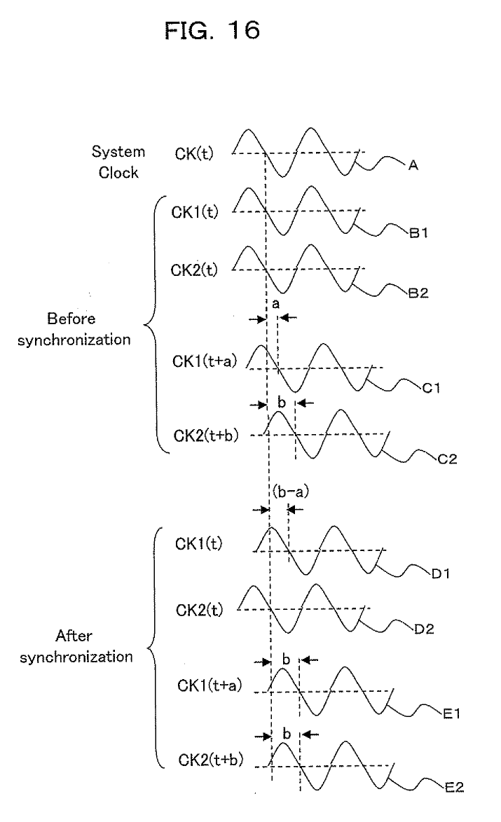

A description will be made hereinafter of an operation mode of the signal processing apparatus 40 with the above described construction. As illustrated in FIG. 16, the phase interpolator 41 outputs the clock signal [CK (t); see reference character A] from the clock supplying source as clock signals CKa(t) and CKb(b) to the clock supply transmission lines 411 and 412, without performing phase adjustment of the clock signal at the stage preceding the establishment of synchronization of the clock signal from the clock supplying source (see reference characters B1 and B2).

The clock signals CKa(t) and CKb(t) propagating through the clock supply transmission lines 411 and 412 are subjected to phase shift due to a difference between the lengths of the transmission lines, and then input to the first ADC system 42a and the second ADC system 42b as the signals CKa (t+a) and CKb (t+b), respectively (see C1 and C2).

The first ADC system 42a and the second ADC system 42b output the clock signals CKa (t+a) and CKb (t+b) to the logic blocks 401 and 402 as digital signals. Then, the phase detector 43 and the integrator 44 use the digital signals from the first ADC system 42a and the second ADC system 42b to calculate the phase deviation Int(phi/df) for phase interpolation.

The phase interpolation processing by use of the phase deviation Int(phi_df) in the phase interpolator 41 makes the clock signals at the time when they are input to the logic blocks 401 and 402 in synchronization with each other. As illustrated in FIG. 16, for example, the phase interpolator 41 performs phase shifting of the clock signal CKa(t) output to the clock supply transmission line 411 by a phase amount of “b-a”. In contrast to this, the phase shift of the clock signal CKb(t) output to the clock supply transmission line 412 is not executed (see reference characters D1 and D2).

With this arrangement, the phase shift amount of the clock signal CKa at the time point at which the clock signal CKa is input to the logic block 401 becomes “b” in combination with the phase shift amount in the clock supply transmission line 411 (see reference character E1). This is equivalent to the phase shift amount of the clock signal CKb at the time it is input to the logic block 402 (see reference character E2), and the synchronization between the clock signals CKa and CKb to the two logic blocks 401 and 402 is realized.

In this manner, according to the fourth embodiment, also, similar to the first embodiment, it is possible to detect an electric signal in a hypersensitive manner to the previous technology. In addition, it is possible to apply the multiple ADC systems 42a and 42b realizing AD conversion with higher accuracy than that of the previous technology. As a result, it is possible to make the clock signals, input from a common clock signal source to multiple digital elements, in synchronization with each other, regardless of a difference of the length between the intermediated transmission lines.

### [e] Fifth Embodiment

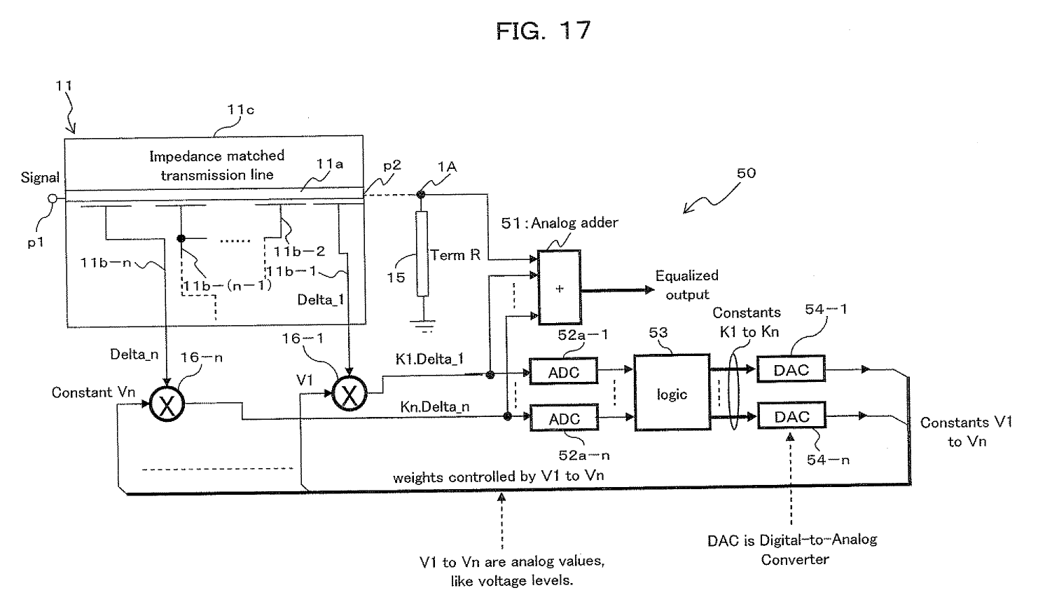

FIG. 17 is a diagram illustrating a signal processing apparatus 50 according to the fifth embodiment. The signal processing apparatus 50 illustrated in FIG. 17 is an equalizer device to which the signal propagation circuit 11 in the above described first embodiment is applied.

Here, the signal processing apparatus 50 illustrated in FIG. 17 differs from the signal processing apparatus 10 [see FIG. 2(A)] according to the above described first embodiment in that the sample holding circuits 12 and 12a-i (i; an integer n not smaller than 1 through 2) are omitted, and an analogue adder 51 are provided. Further, the ADC 52a-i (i; an integer n not smaller than 1 through 2), a logical unit 53, and a Digital to Analogue Converter (DAC) 54-i are provided.

The analogue adder 51 performs analogue addition of the signal (voltage signal) at the input contact A1 and the detection signal having been subjected to resolution correction by the multiplier 16-i together, and then outputs the result of the addition as an equalized output of the signal input to the input end p1.

Further, the logic unit 53 is input thereto with a detection signal having been subjected to resolution correction by the multiplier 16-i as a digital signal by way of the ADC 52a-i, and then separately provides the multiplier 16-i with the resolution correction amount. In this instance, the resolution correction amount (constant Ki) given from the logic unit 53 is converted into an analogue signal in accordance with the correction voltage value by the DAC 54-i, and is given to the multiplier 16-i as Vi. Further, in FIG. 17, reference characters the same as those in FIG. 2(A) indicate approximately the same parts in FIG. 2(A).

In this manner, according to the fifth embodiment, also, it is possible to detect an electric signal in a hypersensitive manner to the previous technology. In addition, it is possible to realize signal equalization processing whose characteristics are improved by use of the signal output (the signal to the input contact A1 and a detection signal output) with an SNR improved in the signal propagation circuit 11, thereby realizing signal equalization processing whose characteristics are improved.

### [f] Sixth Embodiment

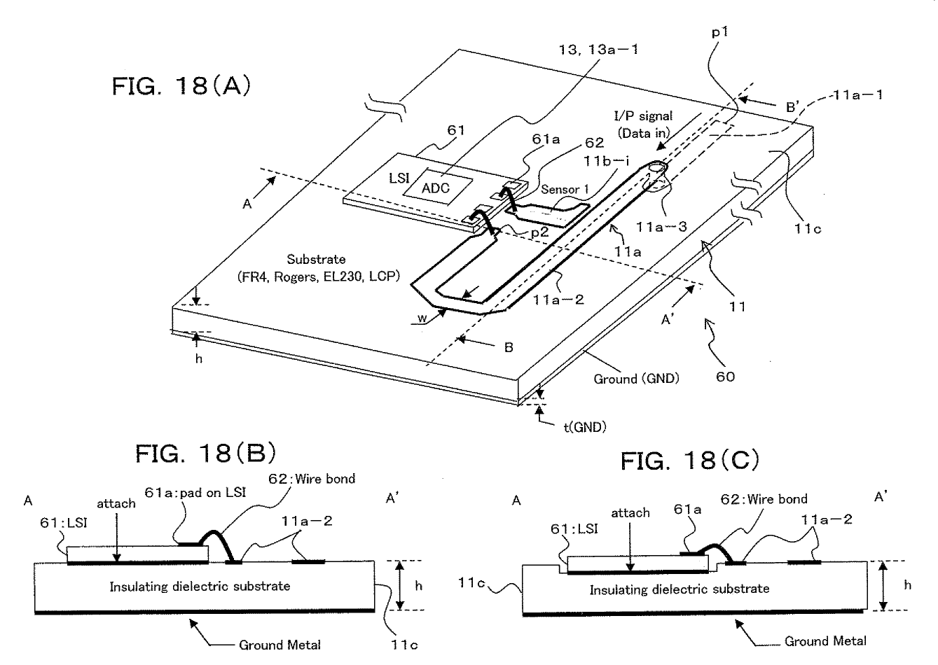

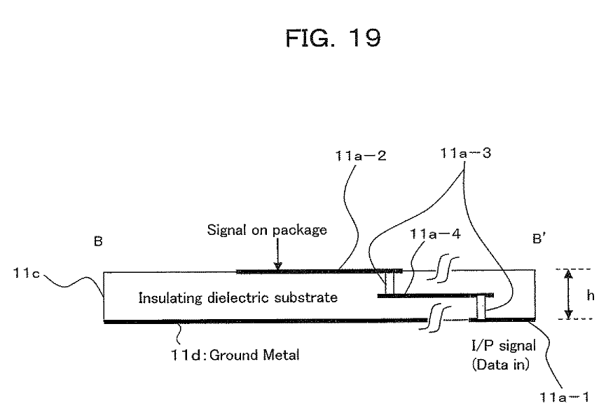

FIG. 18(A) is a schematic perspective view illustrating the signal processing apparatus 60 according to a sixth embodiment. FIG. 18(B) is an example of the A-A′ sectional view of FIG. 18(A); FIG. 18(C) is another example of the A-A′ sectional view of FIG. 18(A); FIG. 19 is the B-B′ sectional view of FIG. 18(A).

The signal processing apparatus 60 illustrated in this FIG. 18(A) is a System in Package (SiP). On the substrate 11c forming the signal propagation circuit 11 of the transmission line pattern #2, an LSI (Large Scale Integration) 61 is mounted as a chip circuit together with the signal propagation circuit 11 according to the above described first embodiment.

The integrated circuit 61 can be provided with functions as at least the sample holding circuits 12 and 12a-i and the ADCs 13 and 13a-I according to the first embodiment. The integrated circuit 61 includes multiple pads 61a, as terminals, which are coupled to the output end p2 of the signal propagation path 11a, the output end of the output end p2, and the output end of the transmission line 11b-i, by way of the wire bond 62. In the FIG. 18(A), the pad 61a is formed at an edge of the upper surface of the main body of the integrated circuit 61.

The integrated circuit 61 can be mounted at the position of the substrate 11c on the surface level the same as that of the position at which the signal propagation path 11a and the transmission line 11b-i are formed as exemplified in FIG. 18(B), and can also be mounted (embedded) at the position on the surface level different from that of the position at which the signal propagation path 11a and the transmission line 11b-i are formed, as exemplified in FIG. 18(C). Further, as exemplified in FIG. 18(B) and FIG. 18(C), the ground connection between the integrated circuit 61 and the substrate 11c is formed by attaching the rear surface of the integrated circuit 61 to the substrate 11c.

The substrate 11c has a height h, and the rear surface of the main body, on which the pad 61a is formed, is grounded by the ground metal 11d laminated with a thickness t. As the material of the substrate 11c, the material with a relatively lower dielectric constant is selected, the width w of the signal propagation path 11a being thereby made larger than the diameter of the pad 61a. As examples, the following materials can be selected: Liquid Crystal Polymer (LCD); insulating dielectric materials for printed circuit boards) such as FR4 and EL230; Rogers; and EL-series materials.

Further, the length of the bended portion of the signal propagation path 11a depicted in FIG. 18(A) can be made to be equivalent to a half of a data cycle (wavelength). Still further, the signal propagation path 11a can be constructed by the propagation parts 11a-1 through 11a-3 as illustrated in FIG. 18(A), or the signal propagation path 11a can be constructed by the propagation parts 11a-1 through 11a-4 as illustrated in FIG. 19.

Here, the first propagation circuit 11a-i illustrated in FIG. 18(A) and FIG. 19 is a signal propagation path formed on the surface (rear surface) opposite to the surface of the substrate 11c on which surface the integrated circuit 61 is mounted. The second propagation path 11a-2 is a signal propagation path formed on the surface of the substrate 11c, on which surface the integrated circuit 61 is mounted. Further, the third propagation path 11a-3 illustrated in FIG. 18(A) is a lead-through conductor that connects the first and the second propagation circuit 11a-i and 11a-2 each other.

Further, the fourth propagation path part 11a-4 illustrated in FIG. 19 is a signal propagation path formed on an inner layer of the substrate 11c. Still further, the third propagation path part 11a-3 illustrated in FIG. 19 is a lead-through conductor that connects the first and the second propagation path parts 11a-1 and 11a-2 each other by way of the fourth transmission path part 11a-4.

This arrangement makes it possible to lead a signal from on the signal propagation circuit 11a-1 formed on the rear surface of the substrate on whose upper surface the integrated circuit 61 is formed. In this instance, in this case, the ground metal 11d is appropriately arranged in such a manner that it is insulated from the first propagation path part 11a-1.

The signal processing apparatus 60 with such a construction is formed in such a manner that the signal propagation circuit 11 and the integrated circuit 61 are integrated with each other. Thus, in addition to advantages similar to those of the above described first embodiment, it is possible to package the signal processing functions of at least the signal propagation circuit 11 and sample holding circuits 12 and 12a-i and the ADCs 13 and 13a-i according to the first embodiment, as a system-in package.

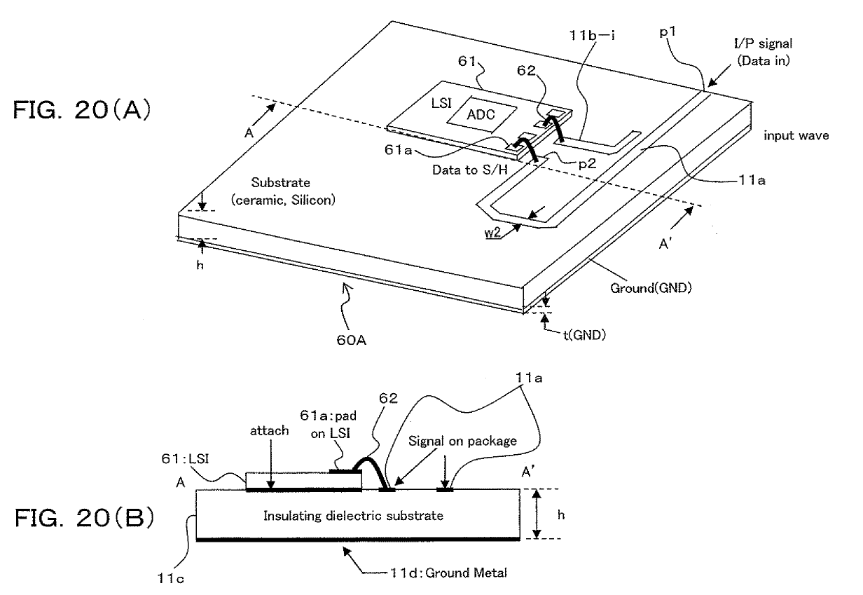

FIG. 20(A) and FIG. 20(B) are diagrams illustrating the signal processing apparatus 60 according to a modified example of the sixth embodiment; FIG. 20(A) is its perspective view; FIG. 20(B) is an A-A′ sectional view. In the signal processing apparatus 60A illustrated in FIG. 20(A) and FIG. 20(B), as the material making the substrate 11c, a relatively low dielectric material is selected, and the width w2 of the signal propagation path 11a is made to be equivalent to the diameter of the pad 61a.

Here, similar to what is illustrated in FIG. 18(A) through FIG. 19, the integrated circuit 61 includes multiple pads 61a, as terminals, which are coupled to the output end p2 of the signal propagation path 11a, the output ends of the output end p2 and the output end of the transmission line 11b-i, by way of the wire bond 62. Different from what are illustrated in FIG. 18(A) through FIG. 19, the signal propagation path 11a is formed on the surface of the substrate 11c, on which surface the integrated circuit 61 is mounted.

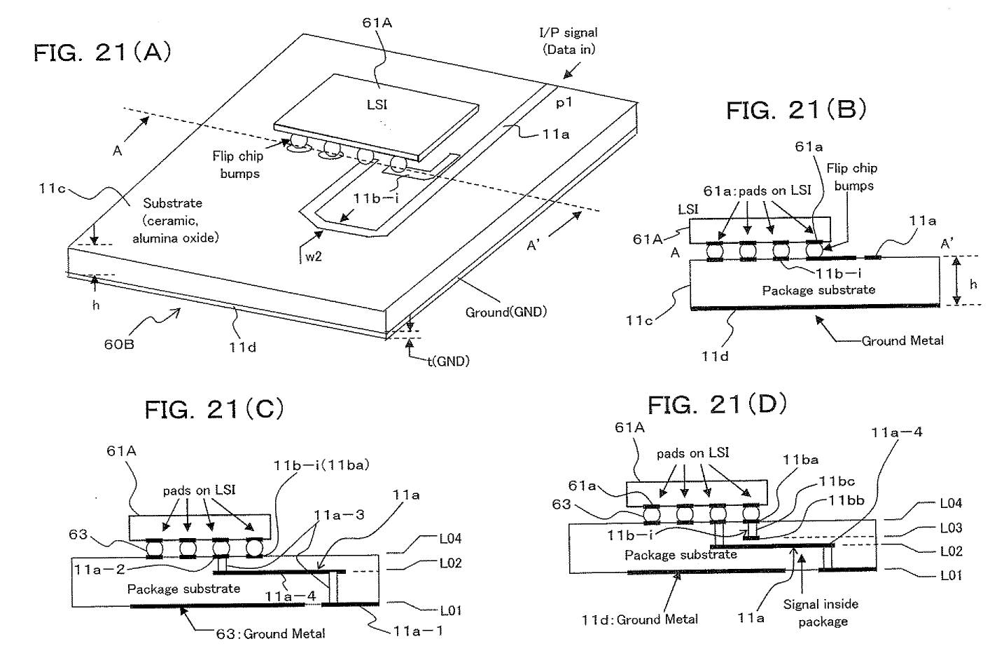

FIG. 21(A) through FIG. 21(D) are diagrams illustrating a signal processing apparatus 60B according to another modified example of the sixth embodiment. FIG. 21(A) is its perspective view; FIG. 21(B) is the A-A′ sectional view of FIG. 21(A); FIG. 21(C) and FIG. 21(D) each illustrate modified examples of what is depicted in FIG. 21(B). Although the signal processing apparatus 60B of FIG. 21(A) includes the signal propagation circuit 11 similar to that which is depicted in the above described FIG. 20(A) and FIG. (B), it is provided with an integrated circuit 61A different in connection mode from the signal propagation path 11a, which forms the signal propagation circuit 11, and the transmission line 11b-i.

That is, as illustrated in FIG. 21(B), the integrated circuit 61A is coupled to the output ends of the signal propagation path 11a and the transmission line 11b-i by flip-chip connection with the FC or the C4 or the like on the substrate 11c. Here, the positions of the connection end parts of the signal propagation path 11a and the transmission line 11b-i are adjusted and arranged in such a manner that they match the pads 61a of the integrated circuit 61A by way of the bumps 63 for flip chip connection. Further, the bumps for flip-chip connection are made of solder or solder and a material of the combination. Still further, as a material used in the substrate 11c, it is possible to select a material relatively high in dielectric constant such as ceramics and aluminum oxicide (Al₂O₃).

When applying the integrated circuit 61A mounted on the substrate 11c with the above described flip-chip connection, the route pattern of the signal propagation path 11a as the signal propagation circuit 11 and the transmission line 11b-i can be assumed to be another pattern.

For example, as illustrated in FIG. 21(C), the integrated circuit 61A is capable of being C4 flip chip-mounted on the signal propagation circuit 11. In this case, the signal propagation path 11a forming the signal propagation path 11 is constructed in the similar manner to those of the signal propagation part 11a-1 through 11a-4. At this time, a non-contact transmission line 11b-i is formed as the signal propagation path 11a for connection with the bumps 63 formed on the substrate 11c. Further, the signal propagation part 11a-3 is capable of being formed as conductor parts for connection with the conductor pads for connection with the bumps 63.

Further, as illustrated in FIG. 21(D), the transmission line 11b-i can be formed by the transmission line portions 11ba through 11bc as the transmission line 11b-i which is non-contacted with the signal propagation path 11a. The transmission line 11ba is formed on the surface of the substrate 11c, on which surface integrated circuit 61A is mounted, thereby forming the conductor for realizing connection with the bumps 63. The transmission part 11bb is a transmission line portion internally embedded in the substrate 11c in the proximity of the signal propagation part 11a-4. Still further, the transmission line portion 11bc is a lead-through conductor coupling the transmission line portions 11ba and 11bb together.

In this instance, in FIG. 21(C) and FIG. 21(D), the reference character L04 indicates the level of the surface on the substrate 11c, on which surface the above described propagation path part 11a-2 and the transmission line portion 11ba are formed; the reference character L03 indicates the internal level of the substrate 11c, on which internal level the signal propagation part 11a-4 is formed. Further, the reference character L02 indicates the internal level of the substrate 11c, on which level the transmission line portion 11bb is formed; the reference character L0 indicates the surface level on the rear surface of the substrate 11c, on which surface the propagation path part 11a-1 and the ground metal 11d are formed.

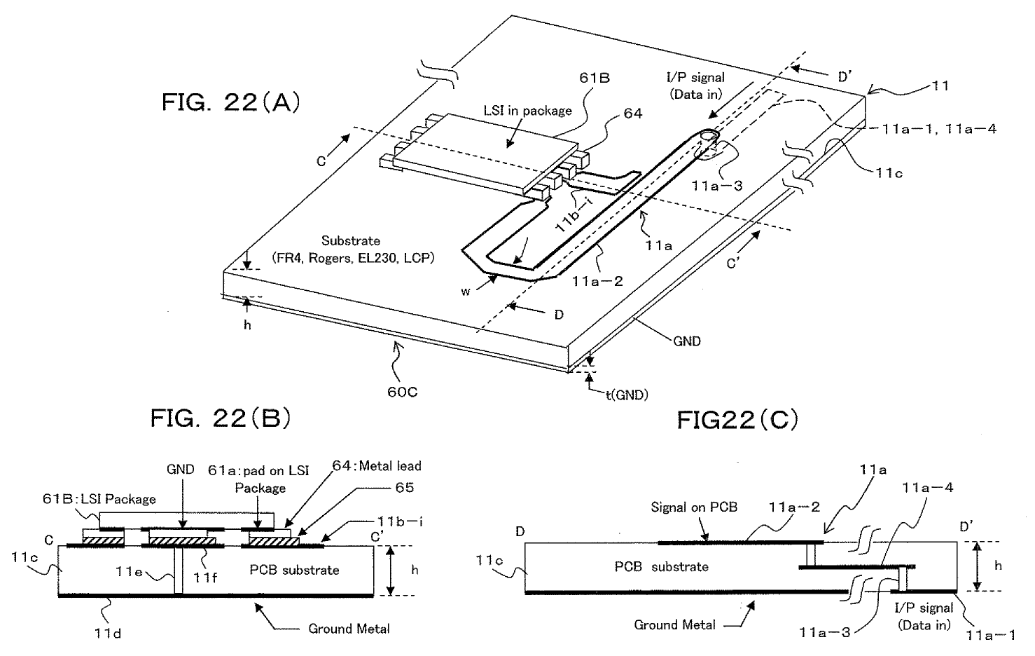

FIG. 22(A) through FIG. 22(C) are diagrams illustrating the signal processing apparatus 60C according to still another modified example of the sixth embodiment. FIG. 22(A) is its perspective view; FIG. 22(B) is the C-C′ sectional view of FIG. 22(A); FIG. 22(C) is the D-D′ sectional view of FIG. 22(A). In the signal processing apparatus 60(C) illustrated in FIG. 22(A), the signal propagation circuit 11 is formed with PCB, and the integrated circuit 61B with the metal leads 64 arranged under the pads 61a is encapsulated by way of the solder layers 65.

In the signal propagation circuit 11 formed by using the PLC technology, the PCB substrate material relatively low in dielectric constant, such as FR4, Rogers, or EL 230, is used as the material for the substrate 11c. Then, as illustrated in FIG. 22(C), the first through the fourth propagation path parts 11a-1 through 11a-4 are prepared as the signal propagation path 11a forming the signal propagation circuit 11a.

Here, the first propagation path 11a-1 is a signal propagation path formed on the surface (rear surface) opposite to the surface on which the integrated circuit 61B in the substrate 11c is mounted. The second propagation path part 11a-2 is a signal propagation path formed on the surface of the substrate 11c, on which surface the integrated circuit 613 is mounted. Further, the fourth propagation path part 11a-4 is a signal propagation path formed on the internal layer of the substrate 11c; the third propagation path 11a-3 is a lead-through conductor that connects the first and the second propagation path part 11a-1 and 11a-2 each other by way of the forth propagation path part 11a-4. Further, the n-number of transmission lines 11b-i (i; 1 through n) are formed on the surface of the substrate 11c, on which surface the integrated circuit 61B is mounted, in a non-contact manner with the signal propagation path 11a.

Then, the end of the transmission line 11b-i, together with one end part of the second propagation part 11a-2 corresponding to the output end p2 of the signal propagation path 11a, are connected to the integrated circuit 61B on which the metal leads 64 and the pads 61a are arranged, by way of the solder layers 65. In this instance, FIG. 22(B) gives illustration with an attention paid to the position at which one end part of the transmission line 11b-i is connected to the integrated circuit 61B.

Further, as illustrated in FIG. 22(B), the ground metal 11d insulated from the signal propagation path 11a-1 is formed on the surface of the substrate 11c opposite to the surface on which the integrated circuit 61B is mounted. Then, this ground metal 11d is made to be into conduction with the ground conductor part 11f formed on the surface of the substrate 11c, on which surface the integrated circuit 613 is mounted, by way of the lead-through conductor 11e.

As to the integrated circuit 61B, the pads 61a are made to be connected to the above described ground body part 11f by way of the metal leads 64 of the pads 61a forming the terminals for grounding, which realizes the grounding of the integrated circuit 61B.

The signal processing apparatuses 60A through 60C with such a construction have a construction in which the signal propagation circuit 11 and the integrated circuits 61, 61A, and 61B are integrated, and thus, the effects and the benefits similar to those of the above described signal processing apparatus 60 are realized.

In this instance, in the signal propagation circuit 11 forming the above described signal processing apparatuses 60 and 60A through 60C, only one transmission line is illustrated as the transmission line 11b-i. However, in obedience to the first embodiment, the number of transmission lines can be made not smaller than one, like in a case where multiple transmission lines are appropriately provided.

Further, although the signal propagation circuit 11 is formed as the transmission line arrangement pattern #2, it can be formed as the transmission line arrangement pattern #1.

### [g] Seventh Embodiment

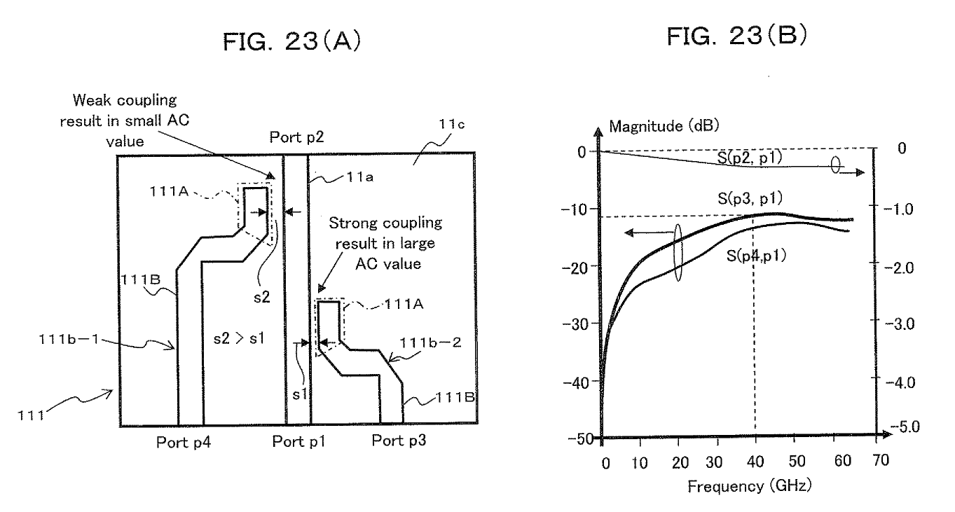

FIG. 23(A) illustrates the signal propagation circuit 111 according to a seventh embodiment. The signal propagation circuit 111 depicted in FIG. 23(A) can be applied as the signal propagation circuit 11 in the above described embodiment, and is another embodiment of the construction illustrated in FIG. 3(B) Here, the signal propagation circuit 111 depicted in FIG. 23(A) has the transmission line 111b-i (i; 1 through n; n=2, here) different from the above described one that is depicted in FIG. 3(B) as described above. In this instance, in FIG. 23(A), reference characters in FIG. 23(A), reference characters the same as those in FIG. 3(n) indicate elements approximately the same as those in FIG. 3(B).

Here, in FIG. 23(A), the signal input from the input end (port p1) propagates through the signal propagation path 11a and is then output through the output end (port p2), As indicated by S(p2, p1) of FIG. 23(B), the signal output from p2 is relatively lower in intensity deterioration across the region from the direct current (0 GHz) to the high-frequency (about 60 GHz). In particular, the direct current component hardly has a deterioration component thereof.

Further, in comparison with the transmission line 111b-2, the transmission line 111b-1 well propagates the detection signal with respect to the signal propagating at the output end side of the signal propagation path 11a and the outputs the detection signal through the output end (port p3).

Here, the transmission lines 111b-1 and 111b-2 include: the first transmission line portion 111A formed in a non-contact manner with the signal propagation path 11a in the horizontal direction at substantially constant intervals halfway through the signal propagation path 11a; and the second transmission line portion 1113 formed in such a manner that it conducts to the first transmission line portion 111A. Then, these first and second transmission line portions 111A and 111B are different from that which is illustrated in FIG. 3(B) in that they are integrally formed at level the same as that of the substrate 11c. Further, it is also possible to form the first and the second transmission line portions 111A and 111B at level the same as that of the signal propagation path 11a.

Here, the distance s2 between the first transmission line portion 111A and the signal propagation path 11a in the transmission line 111b-1 illustrated in FIG. 23(A) is larger than the distance s1 between the first transmission line 111A and the signal propagation circuit 11a (s2>s1). The coupling strength to the signal propagating through the signal propagation path 11a depends on the distance between the first transmission line portion 111A and the signal propagation path 11a.

That is, the transmission line 111b1 with a distance, between the first transmission line portion 111A and the signal propagation circuit 11a, larger than that of the transmission line 111b-2 is relatively smaller in coupling to the signal propagating through the signal propagation path 11a than that of the transmission line portion 111b-2. Therefore, the amplitude of the detection signal (a signal, out of the signals propagating through the signal propagating path 11a, from which signal a direct current component is substantially removed) propagating through the transmission line 111b-1, is relatively small.

On the other hand, the transmission line 111b-2 with a smaller distance between the first transmission line portion 111A and the signal propagation path 11a is relatively larger in coupling to the signal propagating through the signal propagation path 11a than the signal passing through the transmission line 111b-1. For this reason, the amplitude of the detection signal propagating through the transmission line 111b-1 is relatively large.

As a result, in a case where the amplitudes of the signals propagating through the transmission lines 111b-1 and 111b-2 and then are output from the output ends p4 and p3 are compared with each other in accordance to the frequency band, a result indicated in FIG. 23(B) is obtained. As illustrated in FIG. 23(B), the amplitude of each frequency component forming the detection signal is generally larger in the signal S(p4, p1) propagating through the transmission line 111b-2 and then output than in signal S(p3, p1), propagating through the transmission line 111b-1 and then being output.

According to a seventh embodiment, also, similar to the signal propagation path according to the above described first embodiment, it is possible to detect an electric signal with a higher sensitivity than that of the previous technology.

### [h] Eighth Embodiment

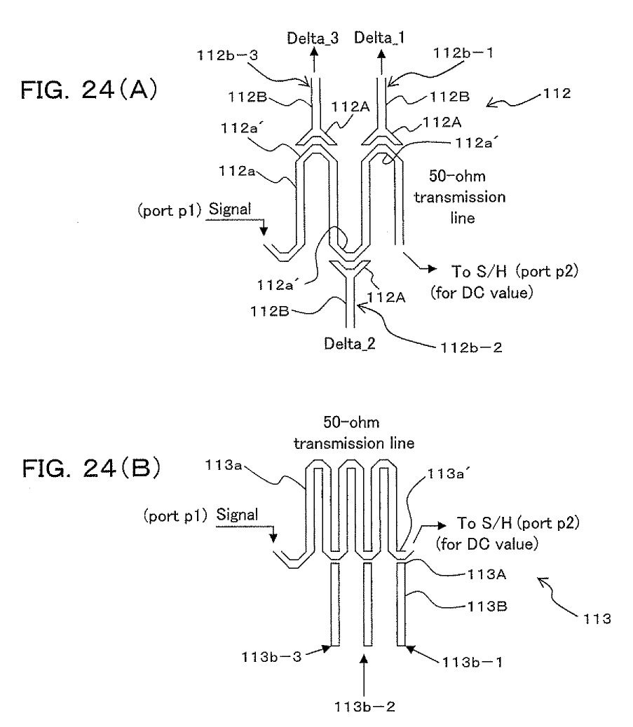

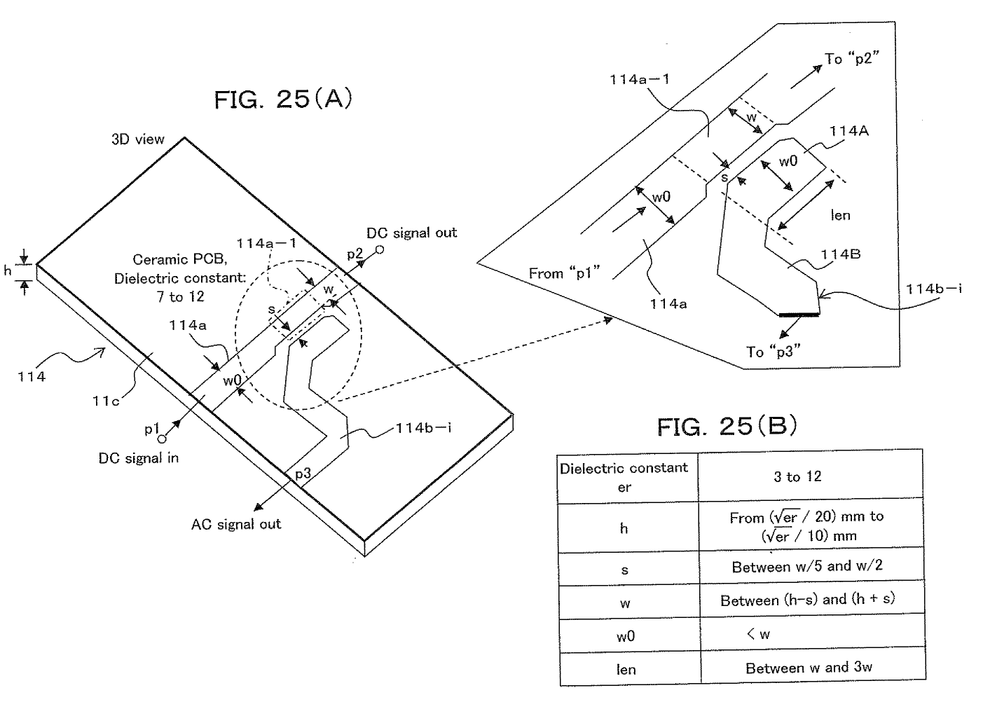

FIG. 24(A) is a diagram illustrating the signal propagating circuit 112 according to an eighth embodiment. The signal propagation circuit 112 can be applied as the signal propagation circuit 11 in each of the above described embodiments, and is another embodiment of the construction illustrated in FIG. 3(B) Here, FIG. 24(A) gives an illustration with an attention paid particularly to the signal propagation path 112a (11a) and the transmission lines 112b-1 through 112b-3 (11b-i), and the illustration of the substrate 11c [FIG. 3(B) or the like] is omitted.

Here, the signal propagation circuit 112 illustrated therein differs from that which is illustrated in FIG. 3(B) in that the signal propagation path 112a includes a bended portion 112a′ thereof and in that three transmission lines 112b-1 through 112b-3 with the different shapes thereof are provided therefore, but the other construction is basically similar to that of FIG. 3(B).

The signal propagation path 112a forming the signal propagation circuit 112 has a bended portion 112a′ between the input end (port p1) and the output end (port p2). That is, the signal propagation circuit 112 depicted in FIG. 24(A) has at least three bended portions 112c in accordance with the positions at which the three transmission lines 112b-1 through 112b-3 are formed in a non-connected manner with the signal propagation path 112a.

Further, the transmission line 112b-i (i; 1 through n; n=3, here) basically has the functions similar to those of the one according to the above described first embodiment. Each transmission line 112b-i includes: the first transmission line portion 112A formed in a non-contact manner with the signal propagation path 11a at substantially constant intervals; and the second transmission path part 112B formed so as to be conducted to the first transmission line portion 112A. At that time, in what is illustrated in FIG. 24(A), the first transmission line portions 112A has a shape that keeps the constant interval in accordance with the bended shape 112a′ of the signal propagation path 112a.

In this instance, as depicted in the signal propagation circuit 113 of FIG. 24(B), it is possible to form the signal propagation path 113a whose length is increased on the substrate 11c having the same scale by means of further narrowing the bended intervals. In this case, the first transmission line portion 113A forming each transmission line 113b-i is made to be a transmission line portion having the same width together with the second signal transmission line 113B. In other words, the first transmission line portion 113A keeps constant intervals to the straight-line portion forming a part of the bended position 113a′ of the signal propagation path 313a.

In the eighth embodiment, also, similar to the signal propagation circuit according to the above described first embodiment, it is possible to detect an electric signal higher in sensitivity than that in the previous technology.

### [i] Ninth Embodiment

FIG. 25(A) is a diagram illustrating a signal propagation circuit 114 according to a ninth embodiment. The signal propagation circuit 114 illustrated in FIG. 25(A) can be applied as the signal propagation circuit 11 according to the above described embodiments, and it is another embodiment of the construction depicted in FIG. 3(B). The signal propagation circuit 114 is provided with a signal propagation path 114a and a transmission line 114b-i different from those which are illustrated in the above described FIG. 3(B) (here, the transmission path 114b-1 due to the transmission arrangement pattern #2). In this instance, the constructions other than the above described one is basically similar to that of FIG. 3(B).

Here, the signal propagation path 114a forming the signal propagation circuit 114 according to the ninth embodiment is provided with the narrow part 114a-1 having a narrow width due to a notch at a position halfway through the signal propagation path 114a at which position the transmission line 114b-1 is formed. More specifically, as to the width of the signal propagation path 114a, the width in the narrow part 114a-1 is made to be w, and the positions other than the narrow part 114a-1 is made to be w0 (>w).

Further, the transmission line signal propagation circuit 114b-i is provided with the first transmission line portion 114A formed in a non-contact manner with the signal propagation path 114a with substantially constant intervals and the second transmission line portion 114B formed so as to be conducted to the second transmission line portion 114B. At that time, the first transmission line portion 114A has an outline shape along the shape of the notch forming the narrow part 114a-1 of the above described signal propagation path 114a (here, the outline shape remains within the notch).

That is, as illustrated in FIG. 25(A), the transmission line 114b-i is formed so as to have the outline and the arrangement such that the first transmission line portion 114A remains within the notch of the narrow part 114a-1. In addition, approximately constant intervals s are provided between the first transmission line portion 114A and the narrow part 114a-1.

As an design example for realizing fine characteristics of the detection signal propagating through the transmission line 114b-i together with the signal propagating through the signal propagation path 114a, a dielectric substrate 11c having a dielectric constant of er and a height of h illustrated in, for example, FIG. 25(B) is applied. Further, the signal propagation path 114a has an interval value s from the transmission line 114b-i illustrated in FIG. 25(B), while the width w of the signal propagation path 114a other than the width w of the narrow part 114a-1 and the narrow width w0 of the propagation path 114a other than the narrow width portion 114a-1. In addition, the coupling length len to the signal propagating path 114a of the first transmission line portion 114A is set.

In this instance, in the signal propagation circuit 114 according to the above described ninth embodiment, also, a case is illustrated in which a single transmission line 114b-1 is provided as the transmission line 114b-i, but it is also possible to make the signal propagation circuit 114 have multiple transmission lines appropriately in obedience to the first embodiment.

As described above, in the signal propagation circuit 114 according to the ninth embodiment, the propagation path 114a is provided with the narrow part 114a-1 as described above. This makes it possible to form an inductive portion for improving the capacity characteristics of the transmission line 114b-i and the signal propagation path 114a.

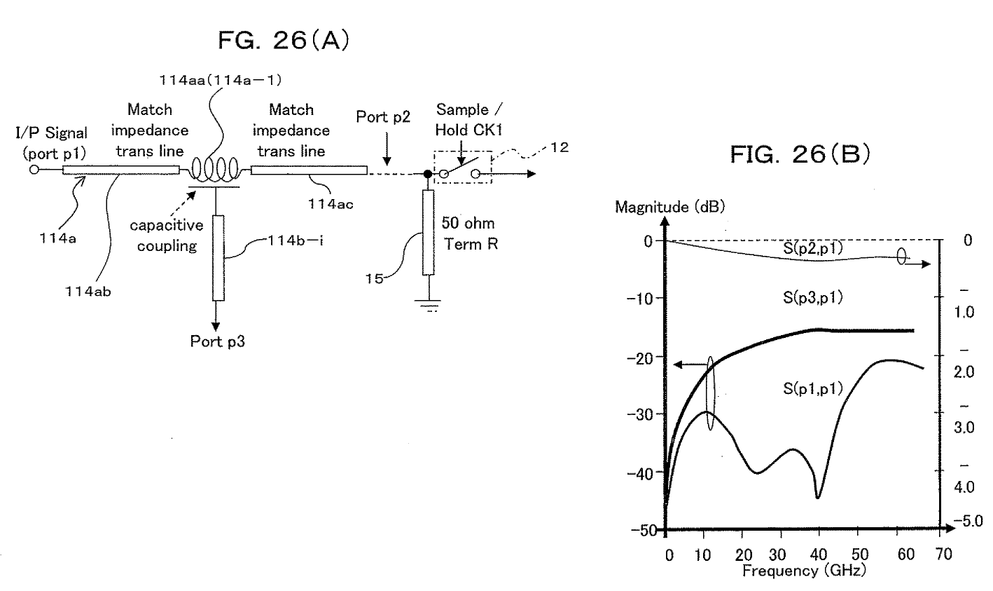

FIG. 26(A) is a diagram illustrating an equivalent circuit of a signal propagation circuit 114 depicted in FIG. 25(A). FIG. 26(A) illustrates a case in which the sample holding circuit 12 is coupled to the signal propagation circuit 114 by way of the terminating is resistor 15.

As illustrated in FIG. 26(A), the inductance 114aa which equivalently corresponds to the narrow part 114a-1 is placed at a position at which the transmission line 114b-i is formed on the signal propagation path 114a. In this instance, the transmission lines 114ab and 114ac provided before and after the inductance 114aa are equivalent to the signal propagation path 114a in a range other than the narrow part 114a1. Further, a total impedance of these propagation paths 114ab and 114ac matches the impedance (for example, 50 ohm) in the terminating resistor 15.

FIG. 26(B) indicates frequency response characteristics of the signal in the signal propagation circuit 114 according to the ninth embodiment. Here, S(p2, p1) in FIG. 26(B) indicates the frequency response characteristics of the signal output from the output end (port p2) of the signal propagation path 114a in response to the signal input from the input end p1. Further, S (p3, p1) of the same figure indicates an example of frequency response characteristic of the detection signal output from the output end (port p3) of the transmission line 114b-1. Still further, S(p1, p1) of the same figure indicates an example of reflection characteristics of the signal input from the input end p1.

As indicated in FIG. 26(B), there is a reflection characteristic of the signal input from the input end p1 such that the magnitude (dB) is capable of being made to be lower than −30 dB in, for example, the 40 GHz band which can be considered as a frequency component contained much in the signal having a bit rate of 40 Gbps. Therefore, by means of applying the signal propagation circuit 114 having such frequency response characteristics, it can be expected that the eye diagram obtained from the signal input to the sample holding circuits 12 of the later stage is made to be fine.

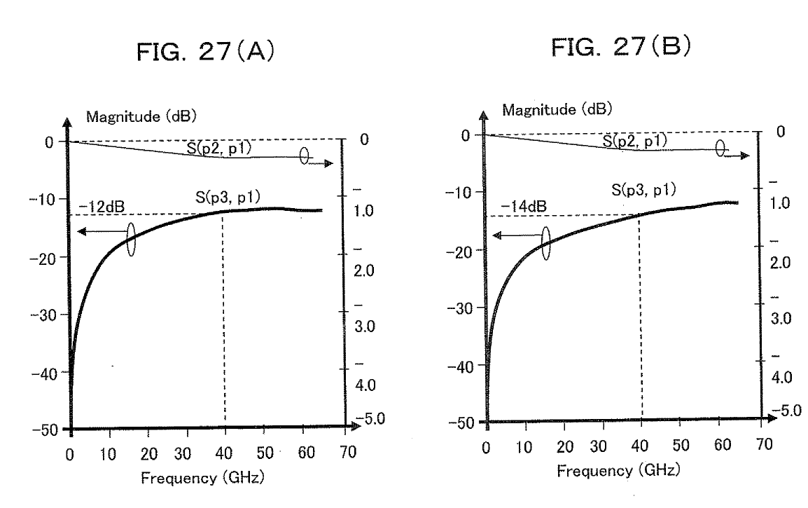

FIG. 27(A) and FIG. 27(B) are diagrams in which the frequency response characteristics of the detection signal are comparatively indicated in accordance with the interval s between the above described narrow part 114a-1 and the first transmission line portion 114A. The interval s in FIG. 27(B) (s=0.05 mm) is narrower than that in FIG. 27(A) (s=0.1 mm), so that it can be said that the coupling strength with the signal propagation path 114a is larger in FIG. 27(A) than in FIG. 27(B).

As illustrated in FIG. 27(A), the magnitude of the detection signal output from the transmission line 114b-1 is −12 dB in the 40 GHz band. In contrast to this, in a case where the interval is made to be wider than that in FIG. 27(A) as s 0.1 mm, the magnitude of the detection signal output from the transmission line 114b-1 is −14 dB in the same frequency band, as indicated in FIG. 27(B).

In this manner, similar to the signal propagation circuit according to the above described first embodiment, it is possible to detect an electric signal with a higher sensitivity than that of the previous technology in the ninth embodiment, too.

### [j] 10th Embodiment

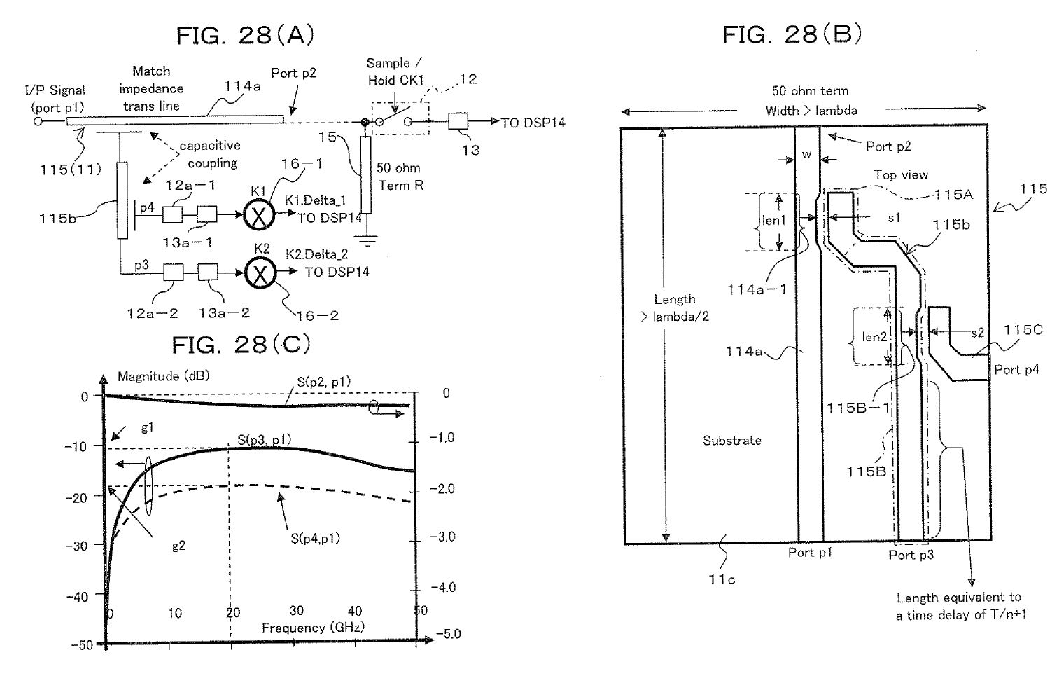

FIG. 28(B) is a diagram illustrating a signal propagation circuit 115 according to a tenth embodiment. The signal propagation circuit 115 illustrated in FIG. 28(B) can be applied as the signal propagation circuit 11 in the above described embodiments, and is another embodiment than the construction depicted in FIG. 3(B) FIG. 28(A) is a diagram illustrating an equivalent circuit with an attention paid thereto in a case where the signal propagation circuit 115 depicted in FIG. 28(B) is applied as the signal propagation circuit 11 of the signal processing apparatus 10 according to the first embodiment.

Similar to the one that is depicted in the above described FIG. 25(A), the signal propagation circuit 115 illustrated in FIG. 28(B) has the signal propagation circuit 114 having the narrow part 114a-1 while it has a cascade transmission line 115b that differs from the transmission line 114b-i depicted in FIG. 25(A). That is, in the signal propagation circuit 115 illustrated in FIG. 28(B), the cascade transmission line 115b is coupled in a non-contact manner with the signal propagation path 114a at a single position, but the is detection signals taken out from the cascade transmission line 115b are two types of detection signals, and are equivalent to the one that substantially has two positions at which non-contact coupling is performed (n=2).

That is, the cascade transmission line 115b has the first and the second transmission line portions 115A and 115B, and further includes the third transmission line portion 115C one of whose end is formed in a non-contact manner with the second transmission line portion 115B at a position halfway therethrough. Here, the first transmission path 115A is formed in a non-contact manner with the signal propagation path 114a substantially at a constant interval s1 in the narrow part 114a-1, which is a position halfway through the signal propagation path 114a. In this instance, the coupling length with the signal propagation path 114a in the first transmission line portion 115A therebetween is len1.

Further, the second transmission line 115B is integrally formed with the first transmission part 115A in such a manner that the end part thereof is lead to the edge part of the substrate 11c while making the end part as port p3 while realizing the conduction with the first transmission line 115A. In what is illustrated in FIG. 28(B), the port p3 is made to be a pattern arranged at the same peripheral part as port p1 of the signal propagation path 114a on the substrate 11c.

Further, the third transmission line portion 115C is formed in such a manner that one end thereof is coupled to the transmission line 115B in a non-contact manner with the second transmission line portion 115B at a position halfway through the second transmission line portion 115B. Here, the position in the second transmission line portion 115B at which the third transmission line portion 15B is formed in a non-contact manner, has a narrow width portion 115B-1 whose width is narrower than that of the position that forms the position forming another of the second transmission line portion 115.

Then, the third transmission line portion 115C is formed, in a non-contact manner having one of the ends thereof, with the coupling length len2, at the position where the above described narrow part 115B-1 is formed. In this instance, the interval between the third transmission line portion 115C and the narrow part 115B-1 is maintained to be a constant interval s2. Further, the other end of the second transmission line portion 115B, which becomes the side opposite to the side coupled to the second transmission line 115B in a non-contact manner, is lead to the peripheral part of the substrate 11c as a port p4.

Here, the position (115B-1) at which the third transmission line portion 115C is coupled to the second transmission line portion 115B in a non-contact manner, is arranged upstream from the port p3, which is the end part of the second transmission line portion 115B by the distance in accordance with predetermined signal propagation time. More specifically, the above position becomes the position upstream from the position of port p3 by the time corresponding to 1/(n+1) of the time T corresponding to the propagation distance from the signal propagation path 114a to the ports p1 and p2.

With this arrangement, the port p4 outputs the detection signal at a time point upstream (or delayed) from the signal output from the port p2, which is the output end of the signal propagation path 114a, for example, by 1/(n+1) (in this case, ⅓) with respect to the propagation length of the signal propagation path 114a. On the other hand, in the port p3, the detection signal at a time point upstream (or delayed) from the signal output from the port p2 by 2/(n+1) (in this case, ⅔) with respect to a propagation length of the signal propagation path 114a.

Therefore, in the signal propagation circuit 115 illustrated in FIG. 28(B), the cascade transmission line 115b makes it possible to operate equivalently to the one substantially having two positions at which non-contact coupling is performed while making the number of positions, at which the non-contact coupling with the signal propagation path 114a is performed, is one. That is, since it is possible to reduce the number of positions at which non-contact coupling to the signal propagation path 114a down to the number in the above described embodiments, it becomes possible to reduce the transmission loss.

In a case where the signal propagation circuit 115 with such a construction is applied to the ADC system, similar to the first embodiment, the result illustrated in FIG. 28(A) is obtained.

That is, the sample holding circuits 12a-1 and 12a-2 each perform sample holding of the detection signals output from the end parts p4 and p3 [see FIG. 28(B)] of the third line portion 115c and the second transmission line portion 115B. Then, the ADCs 13a-1 and 13a-2 each convert the signal from the sample holding circuits 12a-1 and 12a-2 into digital signals Delta_1 and Delta_2. After that, the multipliers 16-1 and 16-2, each, multiply the above described digital signals Delta_1 and Delta_2 by the resolution correction values K1 and K2, individually input from the DSP 14 which is omitted from the illustration thereof, and supply the multiplication results of K1.Delta_1 and K2.Delta_2 to the DSP 14.

On the other hand, the signal propagating though the signal propagation path 114a and output from the output end p2 is output to the DSP 14 as digital signal Data_1 by processing performed by the sample holding circuit 12 and the ADC 13. The DSP 14 outputs the signal, which is an analogue electronic signal input to the input end p1 subjected to digital conversion based on the digital signals from the above described ADCs 13, 13a-1, and 13a-2.

FIG. 28(C) indicates frequency response characteristics in the signals output from the output end p2, the output end p4 of the third transmission line portion 115C, and the output end p3 of the second transmission line portion 115B, in response to the analogue electronic signal input to the input end p1 of the signal propagation circuit 114a.

As illustrated in FIG. 28(C), as to the characteristics S(p2, p1) of the signal from the output end p2, the attenuation amount is small across the high frequency region at about 50 GHz from the DC component. Further, in the characteristics S(p3, p1) and S(p4, p1) of the detection signal output from the output ends p3 and p4 of the second and the third transmission line portion 115B and 115C, although a difference is present in attenuation amount, it can be said that no difference is present in the frequency response characteristics across the region from the low-frequency region to the high-frequency region. That is, both of exhibit larger amplitudes in accordance with the raise in the frequency band at 20 GHz from the direct current as the frequency band becomes higher, but in the frequency band higher than 20 GHz, a change in amplitude exhibited as response is characteristics is hardly found.

That is, the signal output from the output end p4 of the third transmission line portion 115C is larger in attenuation amount than the signal output from p3, since in the signal output from the output end p4 of the third transmission line portion 115C, the number of positions coupled in a non-contact manner in the propagation process in the signal propagation circuit 115 is larger than the signal output from p3 by one. However, since no substantial difference is present in frequency response characteristic between the detection signals output from the output ends p3 and p4, individual correction of the resolution makes it possible for the DSP 14 to cope with the detection signals the same.

For this reason, the DSP 14 supplies the correction values K1 and K2 for individually correcting the resolution of the detection signals output from the output ends p3 and p4 to the corresponding multipliers 16-1 and 16-2. It can be said that the amplitude in a range of 20 GHz through 40 GHz, in which the bit rate is dominant as a frequency distribution of the analogue electric signal at a bit rate of 40 Gbps, is generally the same in the detection signals from the output ends p3 and p4.

Assuming that the amplitude of the detection signal form the output end p3 in the 20 GHz band is g1 and that the amplitude of the detection signal from p4 in the 20 is GHz is g2, a relation between the above described resolution correction values K1 and K2 can be expressed by the following formula (7). In particular, in a case where len1=len2 and s1=s2, the relationship can be expressed by the following formula (8):

K2=K1(g2/g1) (7)

K2=K1·K1 (8)

In this manner, according to the 10th embodiment, the advantages similar to those in the above described first embodiment, and the number of positions connected to the signal propagation path 114a in a non-contact manner is made to be smaller than that of the above described embodiments, so that it becomes possible to reduce transmission loss.

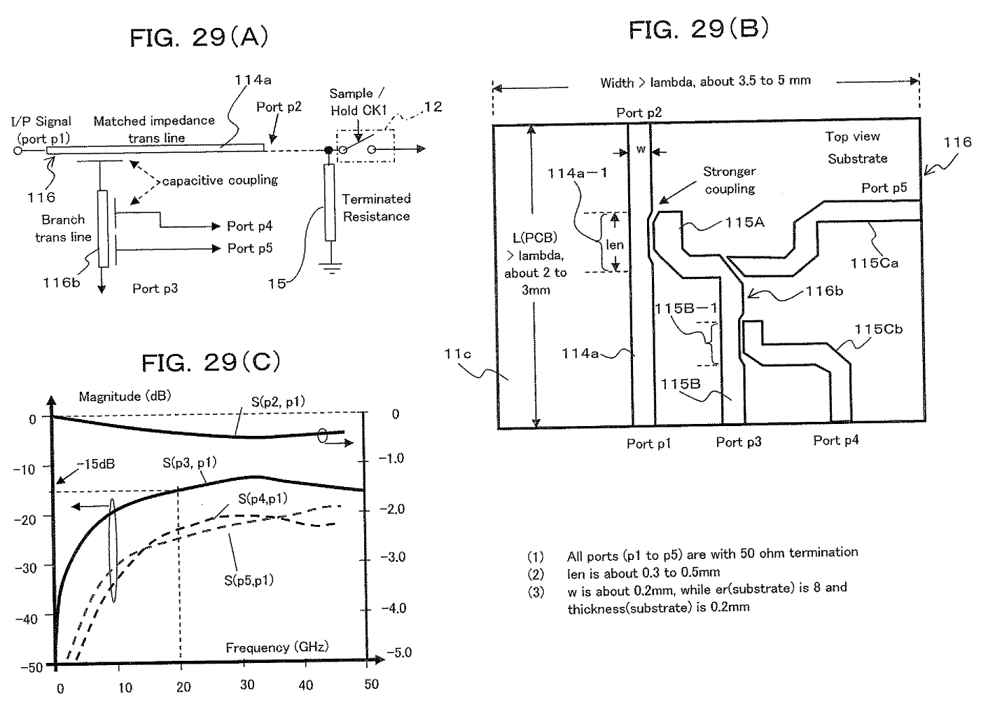

FIG. 29(B) is a diagram illustrating the signal propagation circuit 116 according to a modified example of the 10th embodiment. The signal propagation circuit 116 depicted in FIG. 29(B) is formed as PCB and is provided with a transmission line arrangement different from that of the signal propagation circuit 115 depicted in FIG. 28(B).

That is, the signal propagation circuit 116 illustrated in FIG. 29(B) has a signal propagation path 114 with the narrow part 114a-1, similar to that which is depicted in the above described FIG. 28(B), and also has the cascade transmission line 116b different from the cascade transmission line 115b depicted in FIG. 28(B) The cascade transmission line 116b is different from the cascade transmission line 115b depicted in FIG. 28(B) in that multiple (two, in this case) transmission line portions 115Ca and 115Cb as the third transmission line portion.

That is, one transmission line portion 115Ca of the two third transmission line portions is formed in such a manner that the signal is coupled through one of the ends is non-contacted at the bended portion in the second transmission line portion 115B, and the other end thereof is lead to the port p5. Further, the other transmission line portion 115Cb is formed at the position where the narrow part 115B-1 is formed downstream from the bended portion of the second transmission line portion 115B in such a manner that the signal is coupled even when one of the ends of the transmission line portion 115Cb is non-contacted. The other end is lead to the port p4.

In this instance, as exemplified in FIG. 29(B), the length L corresponding to the direction in which the signal propagation path 114a is formed on the substrate 11c is larger than λ, and can be, for example, about 2 through 3 mm. Here, λ is a signal wavelength propagating through the signal propagation path 11a. Further, the width W of the substrate 11c can be larger than λ, and can be, for example, about 3.5 mm through 5 mm. Still further, the length len of the narrow part 114a-1 is 0.3 mm through 0.5 mm, and the substrate 11c can have a thickness of about 0.2 mm at a dielectric constant of about 0.2 mm.

Similar to the above described signal propagation circuit 115 depicted in FIG. 28(B), the signal propagation circuit 116 exemplified in FIG. 29(B), also, is capable of being applied as the signal propagation circuit 11 in the above described embodiments. As an example, FIG. 29(A) is an equivalent circuit with an attention paid to a case where the signal propagation circuit 116 is applied as the signal propagation circuit 11 in the signal processing apparatus 10 depicted in FIG. 2(A).

The frequency response characteristics in the signals output from the output end p2 of the signal propagation path 114a, the output ends p5 and p4 of the third transmission line portions 115Ca and 115Cb, and the output end p3 of the second transmission line portion 115B are indicated in FIG. 29(C).

Similar to the above described one illustrated in FIG. 28(C), the characteristics S(p3, p1), S(p4, p1), and S(p5, p1) of the detection signals output from the output ends p3, p4, and p5 of the second and the third transmission line portions 115B, 115Cb, and 115Ca, respectively, are different in attenuation amount. However, it can be said that there is not a significant difference in frequency response characteristics from the low-frequency region to the high-frequency region.

That is, in the signals output from the output ends p5 and p4 of the third transmission line portions 115Ca and 115Cb, respectively, the number of positions at which coupling in a non-contact manner in the propagation process is performed in the signal propagation circuit 115 is larger than the signal output from p3 by one. Therefore, in comparison with the attenuation amount in each frequency characteristic, the attenuation amount is larger than that of the signal output from p3. However, the frequency response characteristics between the detection signal output from the output end p3 and the detection signal output from the output ends p5 and p4 are hardly different from each other, so that the detection signals is capable of being coped with the same for AD conversion in the DSP 14 by means of individually correcting the resolution.

This arrangement makes it possible to reduce the number of positions at which non-contact coupling with the signal propagation path 114a is performed in the signal propagation circuit 116 illustrated in FIG. 29(B) in comparison with that in the above described embodiments, so that it is possible to reduce transmission loss.

### [k] 11th Embodiment

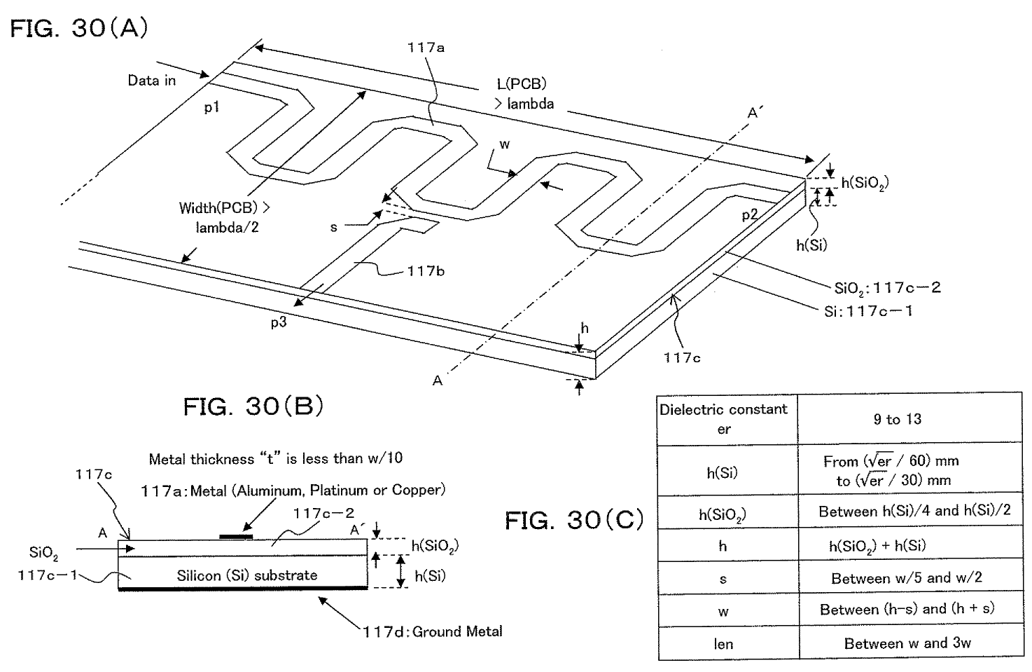

FIG. 30(A) and FIG. 30(B) illustrate a signal propagation circuit 117 according to an 11th embodiment. FIG. 30(A) is its schematic perspective view; and FIG. 30(B) is the A-A′ sectional view in FIG. 30(A). This signal propagation circuit 117 is capable of being applied as the signal propagation circuit 11 in the above described embodiments. In other words, the 11th embodiment is another embodiment in contrast to the one that is depicted in FIG. 3(B).

The signal propagation circuit 117 illustrated in FIG. 30(A) is PCB provided with the signal propagation path 117a realizing conduction between the input end p1 introducing a signal and the output end p2 leading the signal to the terminating resistor 15 side, which is not illustrated, on the substrate 117c. Further, the transmission line 117b is provided with the transmission line 117b in such a manner that one of the ends of the transmission line 117b is non-contacted with the signal propagation path 117a but signal coupling is performed.

As an example, the PCB substrate 117c uses the silicon substrate 117c-1 widely used in cases where the integrated circuit 61 as depicted in the above described FIG. 18(A) or the like is mounted thereon, as an element thereof. Here, since the silicon substrate 117c-1 is made of a semiconductor material, the silicon substrate 117c-2 layer made of SiO2 or the like as illustrated in FIG. 30(B), for example, is placed between the signal propagation path 117a and the transmission line 117b and between the silicon substrate 117c-1 and the silicon substrate 117c-1. That is, the silicon substrate 17c-1 and the layer 117c-2 make the PCB substrate 117c. In this instance, a ground metal 117d, which is a metal layer for grounding, is formed on the surface of the PCB substrate 117c, which surface is opposite to the surface on which the signal propagation path 117a and the transmission line 117b are formed.

Further, as illustrated in FIG. 30(B) as an example, the signal propagation path 117a and the transmission line 117b are laminated on the substrate 117c by use of a metal material such as aluminum, platinum, and copper. Here, the signal propagation path 117a has multiple bended portions which make a rectangular shape as a whole with a width of w. The transmission line 117b, which corresponds to the transmission line 11b-i, is formed at a position substantially a half of the propagation length of the signal propagation path 117a. In this instance, the interval between the signal propagation path 117a and the transmission line 117b regulating the magnitude of the coupling is s.

Still further, the length L in the direction in which the input and the output end p1 and p2 on the PCB substrate 117c is larger than lambda and the width W is larger than λ/2. Here, lambda is a signal wavelength that is input from the input end p1 and propagates, and is expressed by the following formula (9).

lambda=(light speed)/(f·sqrt(er)) (9)

where “light speed” is optical propagation speed in a vacuum; f is a signal frequency; er is dielectric constant of the PCB substrate 117c; and sqrt (er) is the square root of er.

FIG. 30(C) is a table indicating an example set of measures which is an example of the signal propagation circuit 117. In this instance, in FIG. 30(C), h(Si) is the thickness of the silicon substrate 117c-1; h(SiO2) is the thickness of the layer 117c-2; and h is the thickness of the PCB substrate 117c.

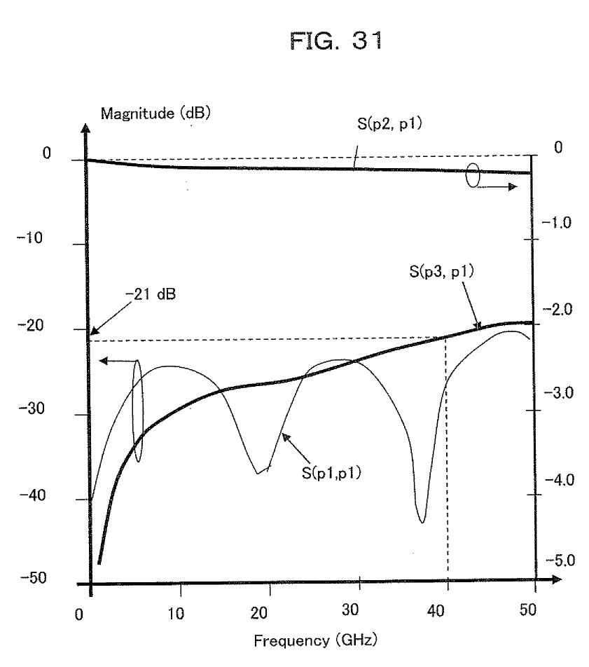

FIG. 31 indicates frequency response characteristics of the signal propagation circuit 117. In FIG. 31, S(p2, p1) is an example of a characteristic of the signal output to the output end p2 of the signal propagation circuit 117a in response to the signal input to the input end p1 of the signal propagation path 117a. Likewise, S(p3, p1) is an example of a frequency response characteristic in the detection signal output from the output end p3 of the transmission line 117b. Further, S(p1, p1) is an example of a characteristic of the reflection signal, which is input from the input end p1 and reflected, thereby being output from the input end p1.

As indicated in FIG. 31, S(p2, p1) is capable of obtaining a fine characteristic regardless of frequency bands, similar to the signal propagation circuit in the above described embodiments. Further, S(p3, p1) hardly includes a direct current component (0 Hz), and the larger, becomes the amplitude, the higher, becomes the frequency band in the frequency band at 20 GHz from the direct current. Then, in the frequency band higher than 20 GHz, the magnitude generally increases in a range between −30 dB and −20 dB with increase in frequency.

Further, as refection signal characteristics, it is possible to make the magnitude smaller than −30 dB in the 20 GHz and 40 GHz bands which are considerable as frequency components much included in the signal having a bit rate, for example, 40 Gbps). Hence, it can be expected that the quality of the signals output from the output ends p2 and p3 is made to be fine by applying the signal propagation circuit 117 having such frequency response characteristics.

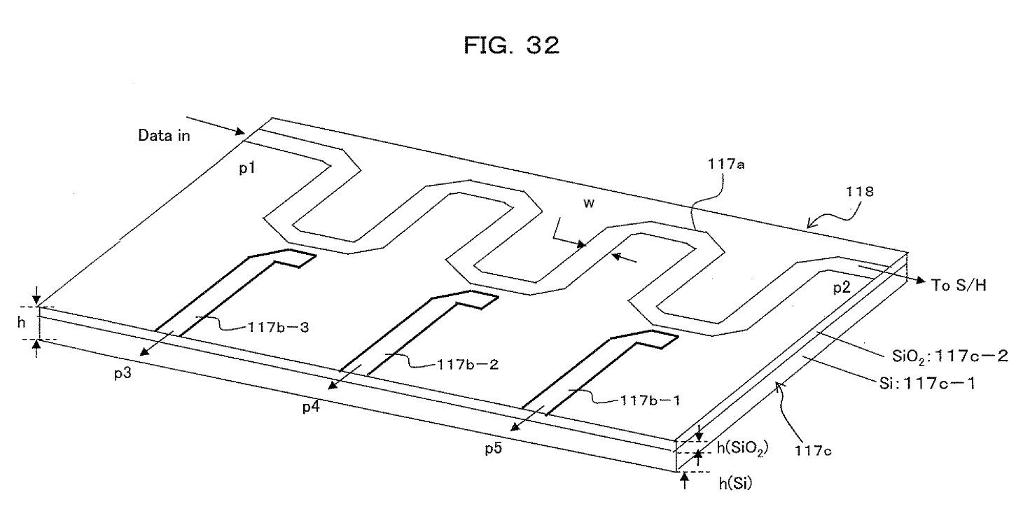

FIG. 32 is a diagram illustrating the signal propagation circuit 118 according to a modified example of the 11th embodiment. The signal propagation circuit 118 depicted in FIG. 32 includes three transmission lines 117b-1 through 117b-3 formed at three positions halfway through the signal propagation path 117a in such a manner that one end of each transmission lines 117b-1 through 117b-3 is non-contacted with the signal propagation path 117a but the signals are coupled thereto. In this instance, in FIG. 32, reference characters in FIG. 32 the same as those in FIG. 30(A) indicate approximately the same elements.

The transmission lines 117b-1 through 117b-3 have the output end p5 through p3, each of which outputs a detection signal, at one of the side edges in the width direction of the PCB substrate 117c. Further, in the one that is exemplified in FIG. 32, the positions of the end parts, which are non-contacted with the signal propagation path 117a, are on one of the edge sides of the signal propagation path 117a, and which are formed straight in the direction of the length of the PCB substrate 117c. Similar to the above described case according to the first embodiment, the transmission lines 117b-1 through 117b-3 can be formed in anon-contact manner with the signal propagation path 117a at the three positions which divide the length of the signal propagation path 117a equally among four.

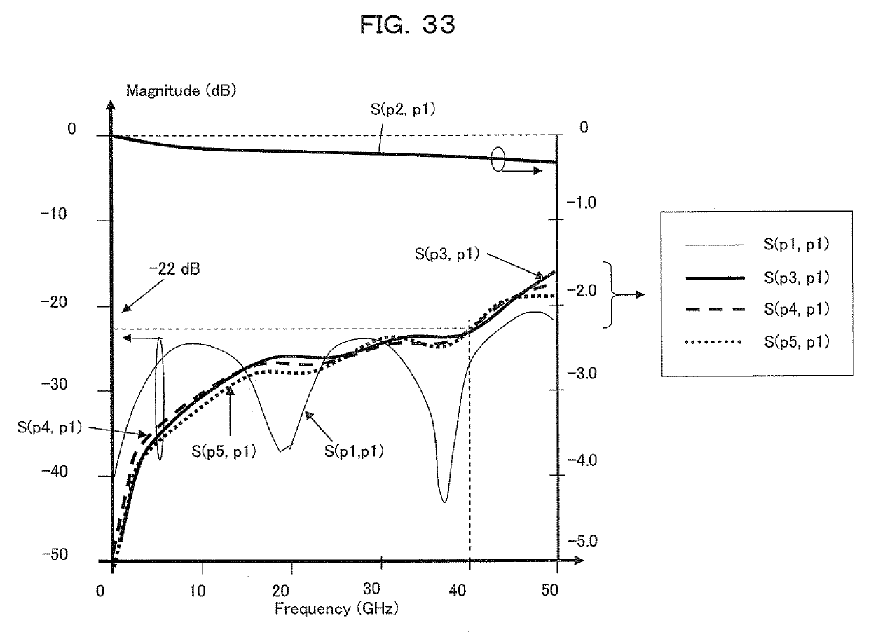

FIG. 33 indicates frequency response characteristics of the signal propagation circuit 118. As indicated in FIG. 33, S(p2, p1) and S(p1, p1) are approximately similar to those in FIG. 31. Further, S(p3, p1), S(p4, p1), and S(p5, p1) indicate the examples of characteristics of the signals output to the output ends p3 through p5 in response to the signal input to the input end p1 of the signal propagation path 117a, and these characteristics are generally equivalent thereamong.

That is, S(p3, p1), S(p4, p1), and S(p5, p1) each are hardly included as the level of the detection signal in the direct current (0 Hz). In the frequency band at 20 GHz from the direct current, the higher, becomes the frequency band, the larger, becomes the magnitude, up to about −30 dB. Then, in the frequency band higher than 20 GHz, the magnitude generally increases in a range between −30 dB through −20 dB with an increase in frequency.

In this manner, similar to the above described signal propagation circuit according to the first embodiment, in the 11th embodiment, it is also possible to detect an electric signal with a higher sensitivity than that of the previous technology.

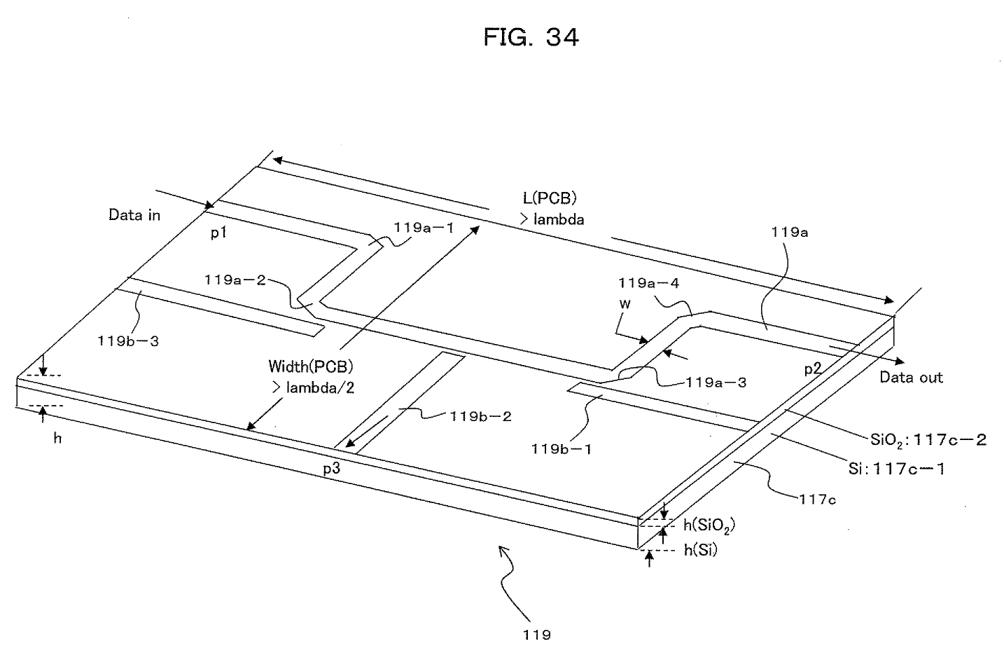

FIG. 34 is a diagram illustrating a signal propagation circuit 119 according to another modified example of the 11th embodiment. This signal propagation circuit 119 has the PCB substrate 117c similar to that of FIG. 32 together with a signal propagation path 119a and transmission lines 119b-1 through 119b-3 having a layout pattern different from that which is depicted in FIG. 32. In this instance, in FIG. 34, reference characters the same as those in FIG. 30(A) and FIG. 32 indicate approximately the same elements.

Here, the signal propagation path 119a has four bended portions 119a-1 through 119a-4. The parts between the bended portions 119a-1 through 119a-4 are formed as a substantially straight propagation path with a width of w. Further, the transmission line 119b-1 is formed at the bended portion 119a-3 in the signal propagation path 119a in such a manner that one of the ends of the transmission line 119b-1 is formed in a non-contact manner with the signal propagation path 119a, so that the signal propagating through the signal propagation path 119a is coupled at that position.

Further, one of the ends of the transmission line 119b-2 is formed in a non-contact manner with the signal propagation path 119a at a substantially straight propagation position between the bended portions 119a-2 and 119a-3 in the signal propagation path 119a. Then, the signal propagating through the signal propagation path 19a is coupled at that position.

Further, one of the ends of the transmission line 119b-3 is formed in a non-contact manner with the signal propagation path 119a at the bended portion 119a-2 in the signal propagation path 119a. With this arrangement, the signal propagating through the signal propagation path 119a is coupled at that position. In this instance, the signals propagating through the transmission lines 119b-1 through 119b-3 at the corresponding positions of the signal propagation path 119a as described above is a signal electrically coupled to the signal propagating through the signal propagation path 119a, and also is a detection signal.

In this instance, the transmission lines 119b-1 through 119b-3 can be formed in a non-contact manner with the signal propagation path 119a at three positions dividing the length of the signal propagation path 119a equally among four. With setting at the bended portions 119a-1 through 119a-4 of the signal propagation path 119a, the three positions at which the signal propagation path 119a is divided equally among four in the signal propagation direction are adjusted appropriately. That is, the three positions can be made to be the above described bended positions 119a-2 and 119a-3 and the intermediate position between the bended portions 119a-2 and 119a-3.

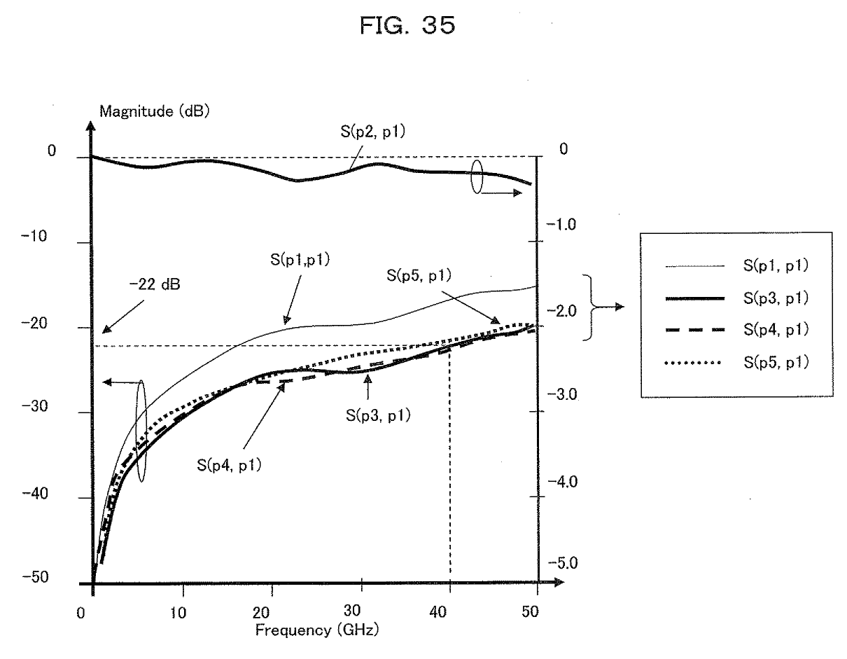

FIG. 35 indicates the frequency response characteristics of the signal propagation circuit 119. S(p2, p1) of FIG. 35 makes it possible to obtain fine characteristics regardless of the frequency band in the similar manner to the above described FIG. 30(A) and FIG. 32. Further, S(p3, p1), S(p4, p1), and S(p5, p1) are examples of characteristics of the signals output to the output ends p3 through p5 in response to the signal input to the input end p1 of the signal propagation path 117a. These characteristics also are generally equivalent to the characteristics in FIG. 33.

Therefore, by applying the signal propagation circuits 118 and 119 having such frequency response characteristics, it can be expected that the quality of the signals output from the output ends p2 through p5 is made to be fine.

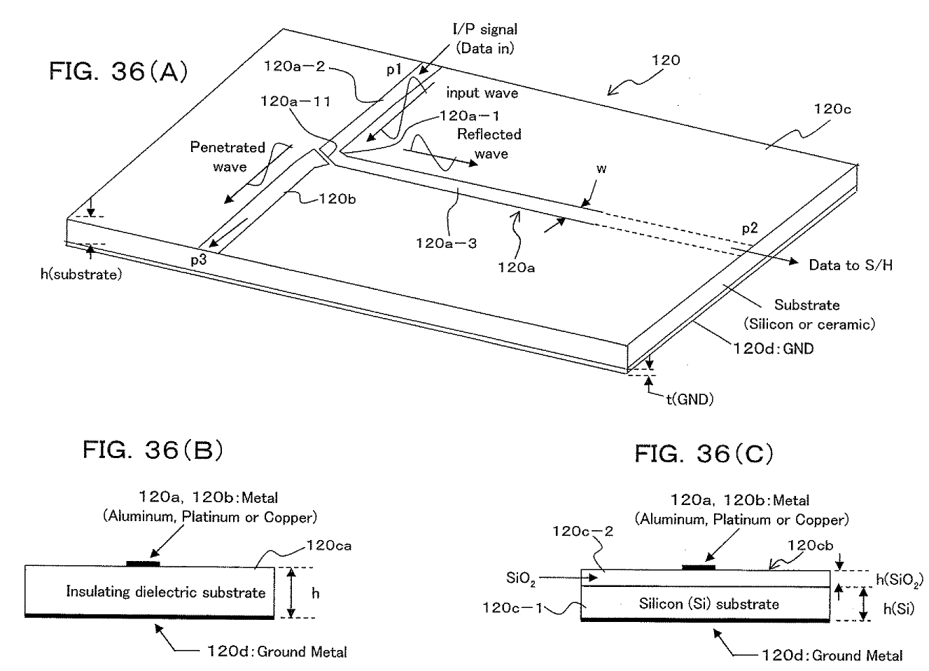

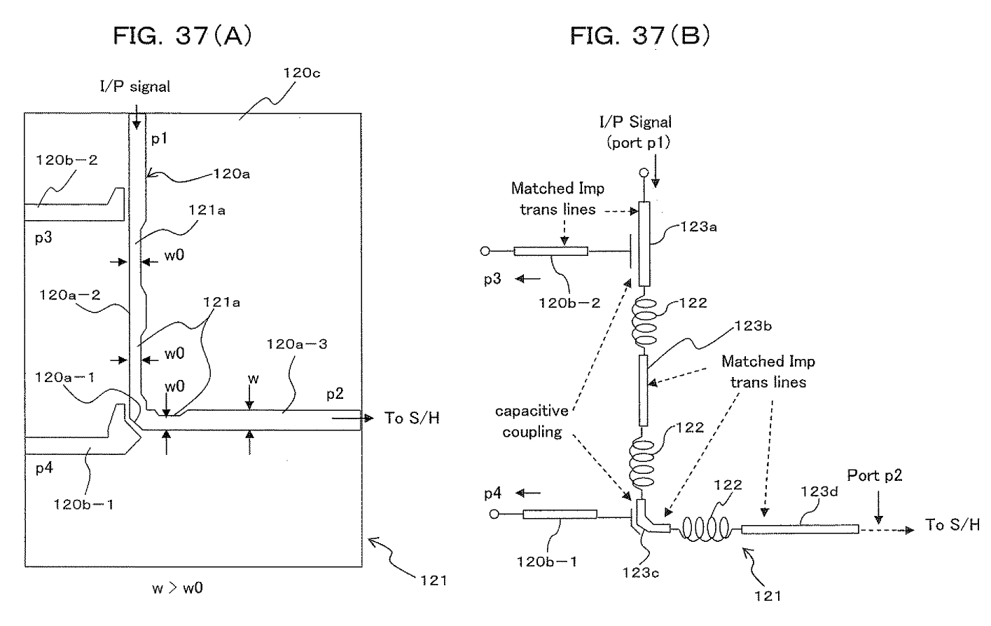

FIG. 36(A) is a diagram illustrating the signal propagation circuit 120 according to another modified example of the 11th embodiment. This signal propagation circuit 120 has the dielectric substrate 120c together with the signal propagation path 120a and the transmission line 120b-1 formed on the dielectric substrate 120c.

As illustrated in FIG. 36(B), the dielectric substrate 120c can be the insulating dielectric substrate 120ca and the substrate 120cb formed by the silicon substrate 120c-1 and the SiO2 layer 120c-2, similar to the one exemplified with the reference character 117c in the above described FIG. 30(A) or the like.

As illustrated in FIG. 36(B) and FIG. 36(C) as examples, the signal propagation path 120a and the transmission line 120b-1 are layered on the dielectric substrate 120c by use of metal material such as aluminum, platinum, and copper. In this instance, in FIG. 36(B) and FIG. 36(C), the reference character 120d indicates a metal layer for grounding.

As illustrated in FIG. 36(A) as an example, the signal propagation path 120a has the shape of a letter L as a whole bended part in which one position is bended substantially at a right angle. In this instance, in FIG. 36(A), the reference character 120a-1 indicates the bended portion of the signal propagation path 120a; the reference character 120a-2 indicates the signal propagation path upstream from the bended portion 120a-1; the reference character 120a-3 indicates the signal propagation path downstream from the bended portion 120a-1.

Here, the signal propagating from the upstream signal propagation path 120a-2 is divided into two components at the bended portion 120a-1: a component (reflection component) deflected in such a manner that the direction of travel is along the downstream signal propagation path 120a-3; and a component (lead-through component) leading through the bended portion 120-1 and being lead to the transmission line 120b-1. At that time, the external side edge 120a-11 in the bended portion 120a-1 is formed so as to substantially form about 45° in the direction in which the upstream and the downstream signal propagation paths 120a-2 and 120a-3 are formed.

Further, one of the ends of the transmission line 120b-1 is formed in a non-contact manner with the signal propagation path 120a at its bended portion 120a-1, thereby propagating the detection signal of the signal propagating through the signal propagation path 120a. That is, the detection signal is lead through the above described bended portion 120-1. Similar to the detection signal in the above described embodiments, the detection signal is coupled to one of the ends of the transmission line 120b-1 in a non-contact manner with the signal propagation path 120a.

Then, one of the ends of the transmission line 120b-1 realizing coupling with the above described signal propagation path 120a is placed opposite to the external side edge 120a-11 of the bended portion 120a-1 at a predetermined interval therebetween. This arrangement increases the efficiency of coupling.

In the signal propagation circuit 120 with such a construction, also, similar to the signal propagation circuit 11 of the above described embodiments, it is possible to increase the detection sensitivity of the signal while keeping the quality of the signal fine.

FIG. 37(A) is a modified example of the signal propagation circuit 120 illustrated in FIG. 36(A). The signal propagation circuit 121 illustrated in FIG. 37(A) further includes the transmission line 120b-2 one of whose ends is formed in a non-contact manner with the upstream signal propagation path 120a-2 at a position halfway therethrough. The signal propagation path 120a has a narrow part 121a, the width w0 at a part of the positions of the signal propagation paths 120a-2 and 120a-3 is narrowed in comparison with the widths at other positions w (w0<w). More specifically, there provided are narrow parts 121a at two positions of the signal propagation path 120 in the part thereof in which ones of the ends of the transmission lines 120b-1 and 120b-2 are arranged in a non-contact manner with the signal propagation path 120 and at one position downstream from the bended portion 120a-1.

The width of the positions of the signal propagation paths 120a other than the narrow part 121a is a width for impedance matching between the signal propagation path 120a and the terminating resistor, which is not illustrated [see the reference character 15 of FIG. 2(A)]. Here, the impedance value of the narrow part 121a is smaller than those at the positions other than the narrow part 121a. Hence, the signal propagation path 120 depicted in FIG. 37(A) is capable of being expressed as an equivalent circuit 120A illustrated in FIG. 37(B).

In the equivalent circuit 120A illustrated in FIG. 37(B), the signal propagation path 120a is formed by the inductance 122 corresponding to the narrow part 121a and the propagation paths 123a through 123d corresponding to the positions of the signal propagation path 120a other than the narrow part 121a. Further, the impedances in the propagation path portion 123a through 123d are subjected to impedance matching with the terminating resistor whose illustration is omitted.

Further, the transmission line 121b-1 performs coupling of the signal propagating at the bended portion forming the propagation path 123c, and the transmission is line 121b-2 performs coupling of the signal propagating through the propagation path 121a.

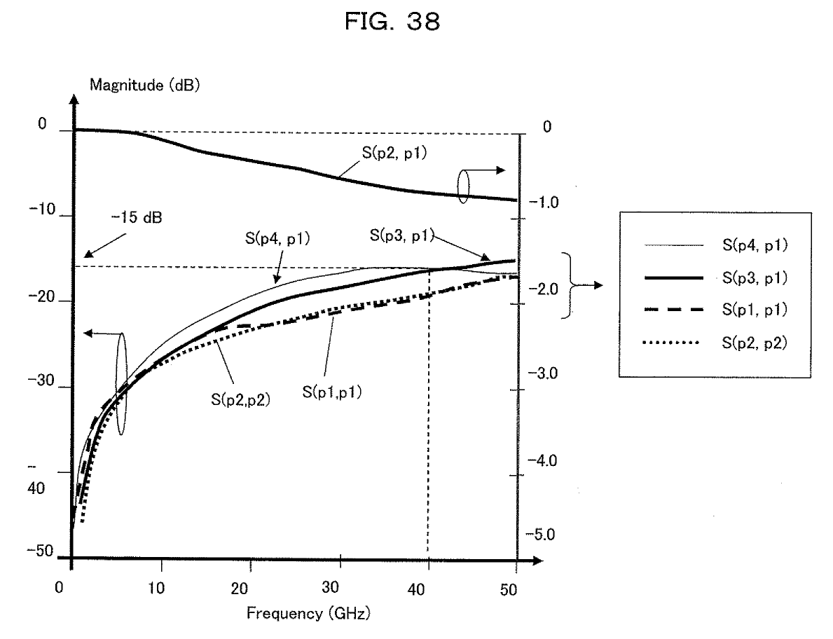

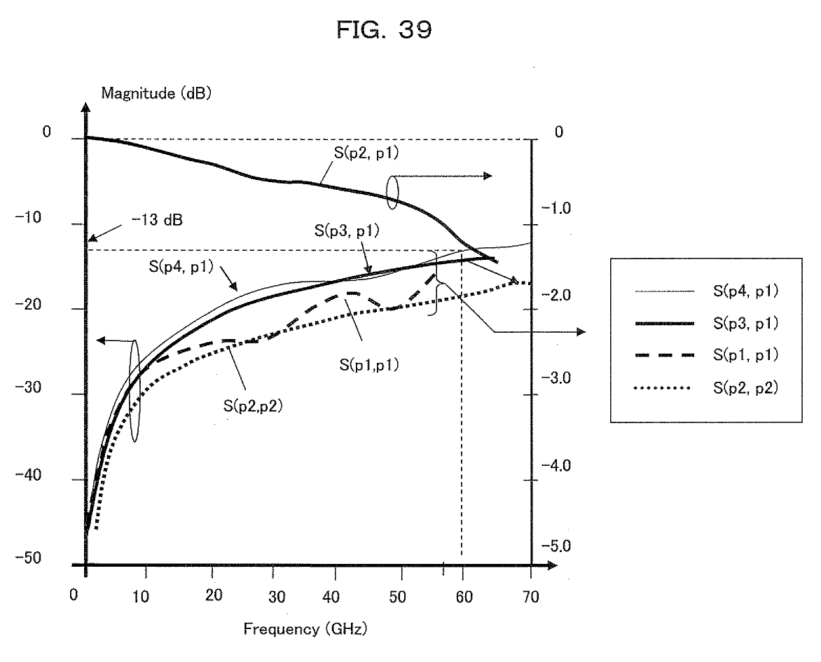

FIG. 38 and FIG. 39 both are diagrams indicating the frequency response characteristics indicated in FIG. 37(A). FIG. 38 indicates the response characteristics from 0 GHz through 50 GHz; FIG. 39 indicates the response characteristics from 0 GHz through 65 GHz and therearound.

As indicated in FIG. 38, the signal input from the input end p1 of the signal propagation path 121a is subjected to coupling, and the detection signals output from the ports p3 and p4, which are the output ends of the transmission paths 121b-1 and 121b-2, are averaged into −15 dB in the 40 GHZ band. Further, as indicated in FIG. 39, the detection signals output from the ports p3 and p4 in a higher frequency band, the 60 GHz band, are averaged into −13 dB.

That is, since the signal propagation path 120a includes the narrow part 121a for adjusting the impedance amount, it is possible to make the frequency response characteristics in the high-frequency band finer, as indicated in the above described FIG. 38 and FIG. 39.

### APPENDIXES

As to the above described embodiments, the following appendixes are disclosed.

(Appendix 1)

A signal propagation circuit, comprising:

a substrate,

the substrate comprising:

a signal propagation path to propagate a signal from an input end, in which signal propagation path a terminating resistance coupled to an output end substantially matches impedance; and

a transmission line formed in a non-contact manner with the signal propagation path halfway trough the signal propagation path.

(Appendix 2)

A signal propagation circuit as set forth in appendix 1, wherein the transmission line propagates a detection signal of the signal propagating through the signal propagation path.

(Appendix 3)

A signal propagation circuit as set forth in appendix 1, wherein a plurality of said transmission lines are formed at substantially equal distances across a length of the signal propagation path from the input end to the output end thereof.

(Appendix 4)

A signal propagation circuit as set forth in appendix 2, wherein each of the plurality of transmission lines propagates a signal in accordance with a signal variation amount at the phase timing corresponding to a distance difference in the signal propagation path from a terminal position thereof to each of the positions at which the transmission lines are formed.

(Appendix 5)

A signal propagation circuit as set forth in appendix 1, wherein the signal propagation path has a length not shorter than a half period length of propagation of a signal that is a subject of the detection.

(Appendix 6)

A signal propagation circuit as set forth in appendix 1, wherein the signal propagation path has a bended part between the input end and the output end.

(Appendix 7)

A signal propagation circuit as set forth in appendix 1, wherein the signal propagation path has a narrow portion for adjusting an amount of impedance, between the input end and the output end.

(Appendix 8)

A signal propagation circuit as set forth in any one of appendix 1 through appendix 7,

wherein the transmission line includes:

a first transmission line portion formed in a non-contact manner with the signal propagation path substantially at a predetermined distance therefrom halfway through the signal propagation path; and

a second transmission line portion formed to conduct to the first transmission line portion.

(Appendix 9)

A signal propagation circuit as set forth in appendix 8 wherein the first transmission line is formed in a non-contact manner with the signal propagation path with a predetermined interval in the depth direction of the substrate.

(Appendix 10)

A signal propagation circuit as set forth in appendix 8 wherein the first transmission line is formed in a non-contact manner with the signal propagation path with a predetermined interval in the horizontal direction.

(Appendix 11)

A signal propagation circuit as set forth in appendix 10,

wherein the signal propagation path has a narrow part which is formed so as to have a narrow width by a notch at a position halfway through the signal propagation path at which position the transmission line is formed, and

wherein the first transmission line part includes an outline shape along the shape of the narrow part.

(Appendix 12)

A signal propagation circuit as set forth in appendix 8, wherein the transmission line further comprises: a third transmission line portion one of the ends of the second transmission line is formed in a non-contact manner with the second transmission line portion at a position halfway through the second transmission line.

(Appendix 13)

A signal processing apparatus, comprising:

a substrate,

the substrate comprising:

a signal propagation path circuit comprising:

a signal propagation path to propagate a signal from an input end, in which signal propagation path a terminating resistance coupled to an output end substantially matches impedance; and

a transmission line formed in a non-contact manner with the signal propagation path halfway trough the signal propagation path; and

a signal processing unit to perform signal processing by use of a second signal output from the transmission line together with a first signal output from the output end of the signal propagation path.

(Appendix 14)

A signal processing apparatus as set forth in appendix 13, further comprising:

a first digitalizing unit to perform sampling of the first signal output from the output end of the signal propagation path in synchronization with the clock, and to output the sampling result as a digital signal; and

a second digitalizing unit to perform sampling of a detection signal of the first signal propagating is through the signal propagation path in synchronization with the clock as the second signal propagating through the transmission line, and to output the sampling result as a digital signal.

(Appendix 15)

A signal processing apparatus as set forth in appendix 14,

the signal processing unit further comprising: a digital signal processing unit to be input thereto with the digital signals from the first digitalizing unit and the second digitalizing unit, and to perform processing or an operation to the signal input through the input end.

(Appendix 16)

A signal processing apparatus as set forth in appendix 15,

wherein the signal propagating through the transmission line is a signal in accordance with the result of light received by a light receiving element, the light being a light signal transmitted after being subjected to optical modulation thereof, and

wherein the digital signal processing unit demodulates data which has been subjected to the optical modulation, by use of the digital signals from the first and the second digitalizing unit.

(Appendix 17)

A signal processing apparatus as set forth in is appendix 15,

the digital signal processing unit performs analogue to digital conversion processing of the signal input through the input end by use of the digital signals from the first and the second digital unit to output the processing result.

(Appendix 18)

A signal processing apparatus as set forth in appendix 15, being input thereto with a phase-modulated digital signal through the input end,

the digital signal processing unit calculating an amount of phase deviation with respect to symbol timing relating to the phase modulation, based on the digital signals from the first digitalizing unit and the second digitalizing unit.

(Appendix 19)

A signal processing apparatus as set forth in appendix 13, further comprising: a light receiving element to receive light and lead a signal according to the light reception result to the input end.

(Appendix 20)

A signal processing apparatus as set forth in appendix 19,

wherein a plurality of said light receiving elements are arranged in an array shape,

the signal processing apparatus further comprising: a selector to selectively switch signals from the plurality of light receiving elements to output the selected signal.

(Appendix 21)

A signal processing apparatus as set forth in appendix 13, the signal processing unit comprising: an adder to add the detection signal input from the transmission line and the signal from the output end together.

(Appendix 22)

A signal processing apparatus as set forth in appendix 15, further comprising: a resolution correcting unit to perform a correction calculation of a resolution of the digital signal from the second digitalizing unit, and to output the digital signal having been subjected to the correction calculation to the digital signal processing unit,

the digital signal processing unit comprising: a resolution correction controlling unit to control the correction calculation performed by the resolution correcting unit, based on the digital signals from the first digitalizing unit and the resolution correcting unit.

(Appendix 23)

A signal processing apparatus as set forth in appendix 13, wherein the signal processing unit is provided for the substrate together with the signal propagation circuit.

(Appendix 24)

A signal processing apparatus, comprising:

a clock signal outputting unit to generate a plurality of clock signals from a common clock;

a plurality of clock supplying transmission lines each to transmit therethrough each of the plurality of clock signals output from the clock signal output unit;

a plurality of phase detecting units each to detect a phase of each of the clock signals supplied through the plurality of clock supplying transmission lines; and

a clock controlling unit to control the clock signal outputting unit,

the plurality of phase detecting units each comprising: a substrate,

the substrate comprising:

a signal propagation path to propagate a clock signal from the corresponding input end, in which signal propagation path a terminating resistance coupled to an output end substantially matches impedance;

a transmission line formed in a non-contact manner with the signal propagation path halfway through the signal propagation path; and

a signal processing unit to induce a phase of the clock signal supplied from the corresponding clock supplying transmission line output as a result of signal processing by use of the first signal output from the output end of the signal propagation path together with the second signal output from the transmission path, and

the clock controlling unit controlling the clock signal outputting unit in such a manner the plurality of clock signals generated by the clock signal outputting unit are substantially in synchronization therewith in accordance with the phases of the clock signals induced by the signal processing units in the plurality of phase detecting units.

### [m] Others

All examples and conditional language recited herein are intended for pedagogical purposes to aid the reader in understanding the principles of the invention and the concepts contributed by the inventors to furthering the art, and are to be construed as being without limitation to such specifically recited examples and conditions, nor does the organization of such examples in the specification relate to a showing of the superiority and inferiority of the invention. Although the embodiment(s) of the present invention(s) has (have) been described in detail, it should be understood that the various changes, substitutions, and alterations could be made hereto without departing from the gist and scope of the concepts.

What is claimed is:

1. A signal propagation circuit, comprising:
a substrate,
the substrate comprising:
a signal propagation path to propagate a signal from an input end, in which signal propagation path a terminating resistance coupled to an output end substantially matches impedance; and
a transmission line formed in a non-contact manner with the signal propagation path halfway trough the signal propagation path.

2. A signal propagation circuit as set forth in claim 1, wherein the transmission line propagates a detection signal of the signal propagating through the signal propagation path.

3. A signal propagation circuit as set forth in claim 1, wherein a plurality of said transmission lines are formed at substantially equal distances across a length of the signal propagation path from an input end to the output end.

4. A signal propagation circuit as set forth in claim 2, wherein each of the plurality of transmission lines propagates a signal in accordance with a signal variation amount at the phase timing corresponding to a distance difference in the signal propagation path from a terminal position thereof to each of the positions at which the transmission lines are formed.

5. A signal propagation circuit as set forth in claim 1, wherein the signal propagation path has a length not shorter than a half period length of propagation of a signal that is a subject of the detection.

6. A signal propagation circuit as set forth in claim 1, wherein the signal propagation path has a bended portion between the input end and the output end.

7. A signal propagation circuit as set forth in claim 1, wherein the signal propagation path has a narrow portion for adjusting an amount of impedance, between the input end and the output end.

8. A signal propagation circuit as set forth in claim 1,
wherein the transmission line includes:
a first transmission line portion formed in a non-contact manner with the signal propagation path substantially at a predetermined distance therefrom halfway through the signal propagation path; and
a second transmission line portion formed to conduct to the first transmission line portion.

9. A signal processing apparatus, comprising:
a substrate,
the substrate comprising:
a signal propagation path circuit comprising:
a signal propagation path to propagate a signal from an input end, in which signal propagation path a terminating resistance coupled to an output end substantially matches impedance; and
a transmission line formed in a non-contact manner with the signal propagation path halfway trough the signal propagation path; and
a signal processing unit to perform signal processing by use of a second signal output from the transmission line together with a first signal output from the output end of the signal propagation path.

10. A signal processing apparatus as set forth in claim 9, further comprising:
a first digitalizing unit to perform sampling of the first signal output from the output end of the signal propagation path in synchronization with the a clock, and to output the sampling result as a digital signal; and
a second digitalizing unit to perform sampling of a detection signal of the first signal propagating through the signal propagation path in synchronization with the clock as the second signal propagating through the transmission line, and to output the sampling result as a digital signal.

11. A signal processing apparatus as set forth in claim 10,
the signal processing unit further comprising: a digital signal processing unit to be input thereto with the digital signals from the first digitalizing unit and the second digitalizing unit, and to perform processing or an operation to the signal input through the input end.

12. A signal processing apparatus as set forth in claim 11,
wherein the signal propagating through the transmission line is a signal in accordance with the result of light received by a light receiving element, the light being a light signal transmitted after being subjected to optical modulation thereof, and
wherein the digital signal processing unit demodulates data which has been subjected to the optical modulation, by use of the digital signals from the first and the second digitalizing unit.

13. A signal processing apparatus as set forth in claim 11,
the digital signal processing unit performs analogue to digital conversion processing of the signal input through the input end by use of the digital signals from the first and the second digital unit to output the processing result.

14. A signal processing apparatus as set forth in claim 11, being input thereto with a phase-modulated digital signal through the input ends
the digital signal processing unit calculating an amount of phase deviation with respect to symbol timing relating to the phase modulation, based on the digital signals from the first digitalizing unit and the second digitalizing unit.

15. A signal processing apparatus as set forth in claim 9, further comprising: a light receiving element to receive light and leads a signal according to the light reception result to the input end.

16. A signal processing apparatus as set forth in claim 15,
wherein a plurality of said light receiving elements are arranged in an array shape,
the signal processing apparatus further comprising: a selector to selectively switch signals from the plurality of light receiving elements to output the selected signal.

17. A signal processing apparatus as set forth in claim 9, the signal processing unit comprising: an adder to add the detection signal input from the transmission line and the signal from the output end together.

18. A signal processing apparatus as set forth in claim 11, further comprising: a resolution correcting unit to perform a correction calculation of a resolution of the digital signal from the second digitalizing unit, and to output the digital signal having been subjected to the correction calculation to the digital signal processing unit,
the digital signal processing unit comprising: a resolution correction controlling unit to control the correction calculation performed by the resolution correcting unit, based on the digital signals from the first digitalizing unit and the resolution correcting unit.

19. A signal processing apparatus as set forth in claim 9, wherein the signal processing unit is provided for the substrate together with the signal propagation circuit.

20. A signal processing apparatus, comprising:
a clock signal outputting unit to generate a plurality of clock signals from a common clock;
a plurality of clock supplying transmission lines each to transmit therethrough each of the plurality of clock signals output from the clock signal output unit;
a plurality of phase detecting units each to detect a phase of each of the clock signals supplied through the plurality of clock supplying transmission lines; and
a clock controlling unit to control the clock signal outputting unit,
the plurality of phase detecting units each comprising: a substrate,
the substrate comprising:
a signal propagation path, comprising:
a signal propagation path introducing thereto a clock signal from the corresponding clock supplying transmission line from an input end of the signal propagation path, to propagate the clock signal, in which signal propagation path a terminating resistor coupled to an output end substantially matches impedance; and a transmission line which is formed in a non-contact manner with the signal propagation path at a position halfway through the signal propagation path; a signal processing unit to induce a phase of the clock signal supplied from the corresponding clock supplying transmission line output as a result of signal processing by use of the first signal output from the output end of the signal propagation path together with the second signal output from the transmission path, and
the clock controlling unit controlling the clock signal outputting unit in such a manner the plurality of clock signals generated by the clock signal outputting unit are substantially in synchronization therewith in accordance with the phases of the clock signals induced by the signal processing units in the plurality of phase detecting units.
